(19) United States
(12) Patent Application Publication
(10) Pub. No.: US 2024/0308769 A1
(43) Pub. Date: Sep. 19, 2024

(54) WAREHOUSING SYSTEM FOR STORING AND RETRIEVING GOODS IN CONTAINERS

(71) Applicant: Symbotic LLC, Wilmington, MA (US)

(72) Inventor: Jeffrey Adam Traina, Wilmington, MA (US)

(21) Appl. No.: 18/605,294

(22) Filed: Mar. 14, 2024

Related U.S. Application Data
(63) Continuation of application No. 63/452,758, filed on Mar. 17, 2023.

(51) Int. Cl. B65G 1/137

(52) U.S. Cl. CPC B65G 1/1375; B65G 2201/0258

(57) ABSTRACT

An automatic product tote destacker tool comprising, a frame with a coupling configured so as to mate the automatic product tote destacker tool to a robot end so that the automatic product tote destacker tool provides the robot with an end effector, a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head, and a drive section connected to the frame and operably coupled to each tote pick head to move the tote pick head as a unit.

### CROSS-REFERENCE TO RELATED APPLICATIONS

This application is a non-provisional of and claims the benefit of U.S. provisional patent application No. 63/452,758 filed on Mar. 17, 2023, the disclosure of which is incorporated herein by reference in its entirety.

### BACKGROUND

### 1. Field

The disclosed embodiment generally relates to material handling systems, and more particularly, to transport and storage of items within the material handling system.

### 2. Brief Description of Related Developments

It is well recognized that integration of automated storage and retrieval systems into a logistic chain, particularly goods to man systems, are highly advantageous throughout efficiency and cost of the logistics chain. Conventional systems, even with a high level of automated storage and retrieval system integration in a logistic facility operate generally by storing product (e.g., supply) containers, where the supply containers include cases, packs, etc. that contain a common type of goods (also referred to as products) in the supply containers. The product containers may arrive on pallets (e.g., of common supply containers) or as truck loads, and are either depalletized or unloaded from trucks, and stored in the logistics facility, distributed throughout the storage volume (e.g., in a three-dimensional array of storage racks) of the logistic facility by the automated storage and retrieval system.

Order fulfillment from the logistic facility, particularly in the event that mixed product containers are desired (e.g., wherein any given order container may have mixed/different products or product types held by a common container such as in cases of direct to consumer fulfillment, or if indirect to consumer, such as via a retail order pick up location, the ordered mix of products in the order container is generated, at least in part, at the logistic facility prior to output from the logistic facility) conventionally, generation of mixed product containers is effected with the automated storage and retrieval system goods to person configuration by the automated storage and retrieval system outputting the product/supply containers (each containing one or more goods items of a common good type, i.e., each goods item in the product container is the same or substantially similar) from storage locations throughout the three-dimensional array of storage racks to workstations, manual or automated, to pick and remove goods from the different product/supply containers, fed by the automated storage and retrieval system to the given workstation, pursuant to a given fulfillment (or fill) order, and to place the different picked goods (mixed or common if a given order contained is so filled) into order containers. Such workstations may be referred to as breakpack stations, wherein the product container is “broken” down and its contents may be placed in order containers in whole or in part, or into what may be referred to as a breakpack storage container such as where the product container is unsuitable for continued holding of remaining product items after the breakpack operation, and such remaining products (i.e., the remainder of products in the “broken” down product container) should be returned to storage in the three-dimensional array of storage racks by the automated storage and retrieval system. Generally, containers are manually destacked and placed at the breakpack stations via an operator or an automated guided vehicle for fulfillment by the system.

### BRIEF DESCRIPTION OF THE DRAWINGS

The foregoing aspects and other features of the disclosed embodiment are explained in the following description, taken in connection with the accompanying drawings, wherein:

FIG. 1 is a schematic illustration of an automated storage and retrieval system in accordance with aspects of the disclosed embodiment;

FIGS. 2, 3, and 4 are schematic illustrations of portions of the automated storage and retrieval system in accordance with aspects of the disclosed embodiment;

FIG. 5 is a schematic illustration of a mixed pallet load formed by the automated storage and retrieval system in accordance with aspects of the disclosed embodiment;

FIG. 6 is a schematic illustration of a portion of the automated storage and retrieval system in accordance with aspects of the disclosed embodiment;

FIG. 7 is a schematic illustration of a portion of the automated storage and retrieval system in accordance with aspects of the disclosed embodiment;

FIGS. 8, 9, 10, 11, and 12 are schematic illustrations of portions of the storage and retrieval system in accordance with aspects of the disclosed embodiment;

FIG. 13 is a schematic illustration of a transport vehicle in accordance with aspects of the disclosed embodiment;

FIG. 14 is a schematic illustration of a transport vehicle in accordance with aspects of the disclosed embodiment;

FIG. 15 is a schematic illustration of the tote in a partially closed configuration in accordance with aspects of the disclosed embodiment;

FIGS. 16A and 16B are schematic illustrations of a tote destacking system with an automatic product tote destacker tool of the automated storage and retrieval system in accordance with aspects of the disclosed embodiment;

FIGS. 17-20 are schematic illustrations of various portions of the automatic product tote destacker tool of FIG. 4 in accordance with aspects of the disclosed embodiment; and

FIGS. 21-22 are exemplary flow diagrams of methods in accordance with aspects of the disclosed embodiment.

### DETAILED DESCRIPTION

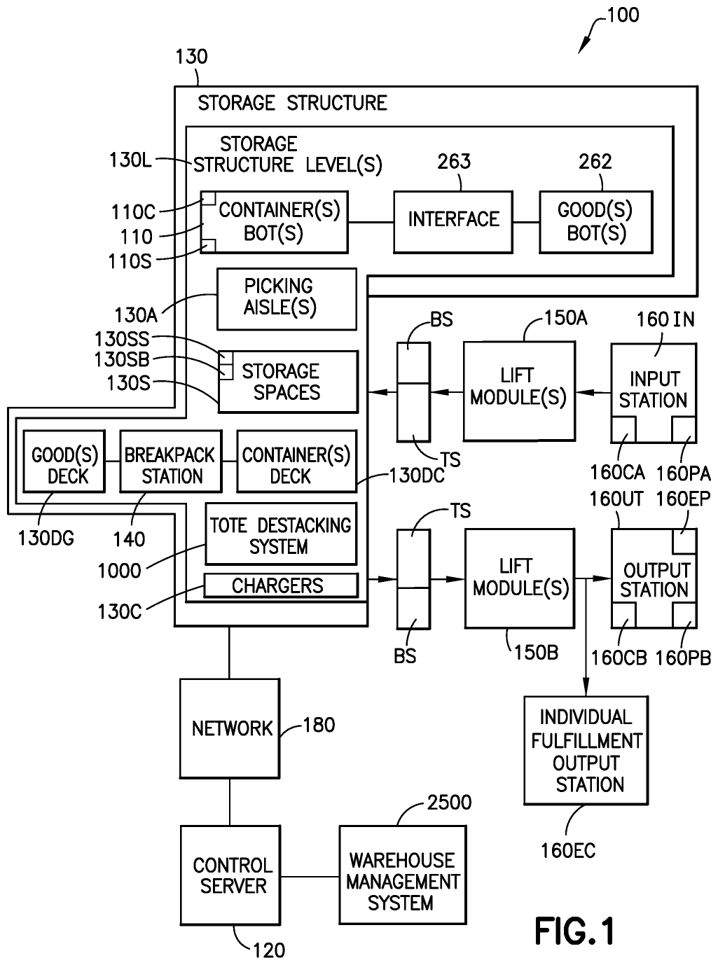

FIG. 1 is a schematic illustration of an automated storage and retrieval system (also referred to herein as a warehousing/warehouse system or product order fulfillment system) 100 in accordance with aspects of the disclosed embodiment. Although the aspects of the disclosed embodiment will be described with reference to the drawings, it should be understood that the aspects of the disclosed embodiment could be embodied in many forms. In addition, any suitable size, shape or type of elements or materials could be used.

In accordance with aspects of the disclosed embodiment the automated storage and retrieval system 100 may operate in a retail distribution center or warehouse to, for example, fulfill orders received from retail stores for case units such as those described in U.S. Pat. No. 10,822,168 issued on Nov. 3, 2020, the disclosure of which is incorporated by reference herein in its entirety. For example, the case units are cases or units of goods not stored in trays, in totes 1510A-n or on pallets (e.g., uncontained). In other examples, the case units are cases or units of goods that are contained in any suitable manner such as in trays, in totes 1510A-n, in containers (such as containers of remainder goods after breakpack where the broken down case unit structure is unsuitable for transport of the remainder goods as a unit) or on pallets. In still other examples, the case units are a combination of uncontained and contained items. It is noted that the case units, for example, include cased units of goods (e.g., case of soup cans, boxes of cereal, etc.) or individual goods that are adapted to be taken off of or placed on a pallet. In accordance with the aspects of the disclosed embodiment, shipping cases for case units (e.g., cartons, barrels, boxes, crates, jugs, or any other suitable device for holding case units) may have variable sizes and may be used to hold case units in shipping and may be configured so they are capable of being palletized for shipping. It is noted that when, for example, bundles or pallets of case units arrive at the storage and retrieval system 100 the content of each pallet may be uniform (e.g., each pallet holds a predetermined number of the same item—one pallet holds soup and another pallet holds cereal) and as pallets leave the storage and retrieval system 100 the pallets may contain any suitable number and combination of different case units (e.g., a mixed pallet where each mixed pallet holds different types of case units—a pallet holds a combination of soup and cereal) that are provided to, for example the palletizer in a sorted arrangement for forming the mixed pallet. In the aspects of the disclosed embodiment, the storage and retrieval system 100 described herein may be applied to any environment in which case units are stored and retrieved.

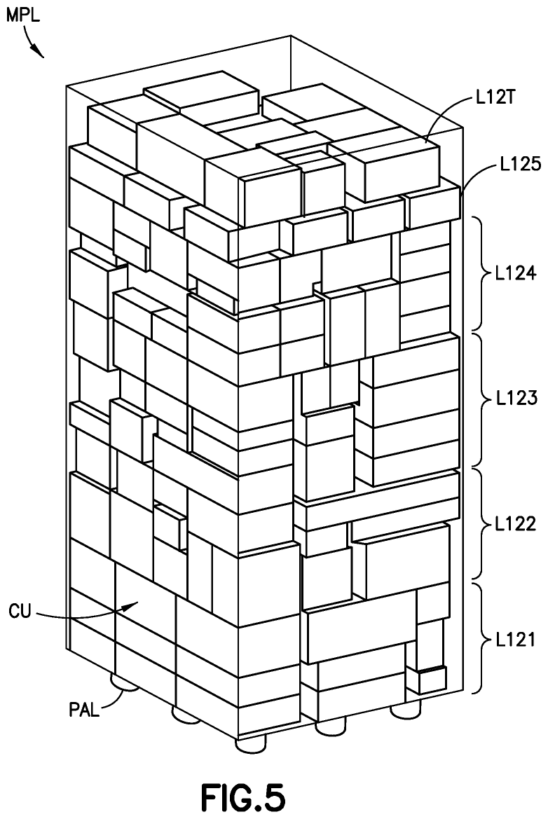

In accordance with aspects of the disclosed embodiment, orders for filled items (e.g., the pallets, cases, containers, package of goods, individual (unpacked) goods, etc.) may be stochastic (e.g., substantially random in the items ordered and a time the order is received) and may be fulfilled by the automated storage and retrieval system 100 as function of time (e.g., sortation of ordered goods at a predetermined scheduled time in advance of a time the order is to ship/be fulfilled or in a sortation of goods in a just-in-time manner). These stochastic orders are determinative of a pick sequence of sorted items, such as for building a pallet load or pallet PAL as described herein with respect to FIG. 5 (see also, e.g., U.S. Pat. No. 8,965,559 titled “Pallet Building System” and issued on Feb. 24, 2015, the disclosure of which is incorporated herein by reference in its entirety). While the pallet in FIG. 5 is illustrated and described as a mixed case pallet, such illustration is also representative of a pallet load having mixed cases, mixed totes, mixed packs, mixed units (or eaches) per tote, etc. Here, the sorted items are picked from a common storage array (e.g., a storage array formed by storage spaces 130S of storage structure 130). The automated storage and retrieval system 100 effects a maximum throughput of goods for each order (e.g., received for processing by the automated storage and retrieval system 100) by employing or otherwise processing the order through one or more of the orthogonal sortation echelons (such as described in, for example, U.S. patent application Ser. No. 17/358,383 filed on Jun. 25, 2021 and titled “Warehousing System for Storing and Retrieving Goods in Containers,” the disclosure of which is incorporated herein by reference in its entirety) to a sortation level needed (e.g., the controller 120 drills/drives down through the orthogonal sortation echelons to effect the desired level of sortation needed for a given order—a case level sortation, a pack level sortation, a unit/each level sortation or a combination thereof) to effect a given order from the common storage array independent of order type (e.g., a pallet order, a case order, a pack order, mixed orders, etc.), independent of order sequence, and independent of order time.

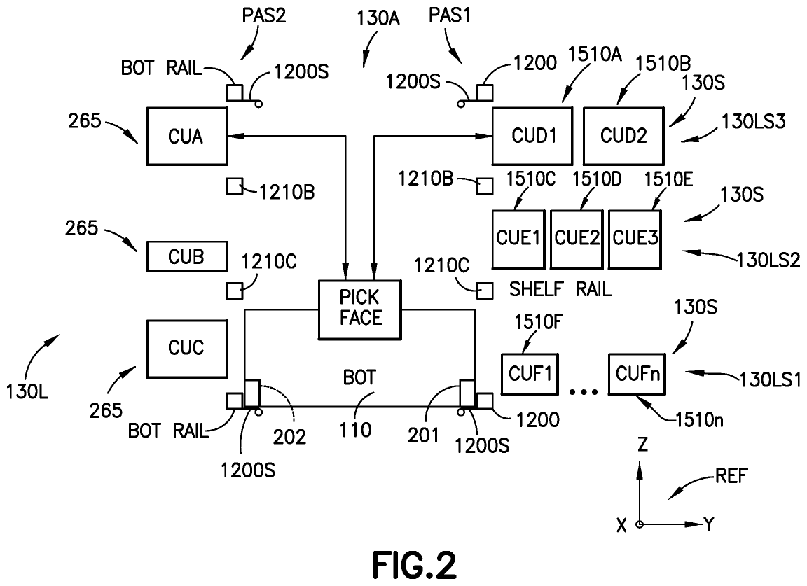

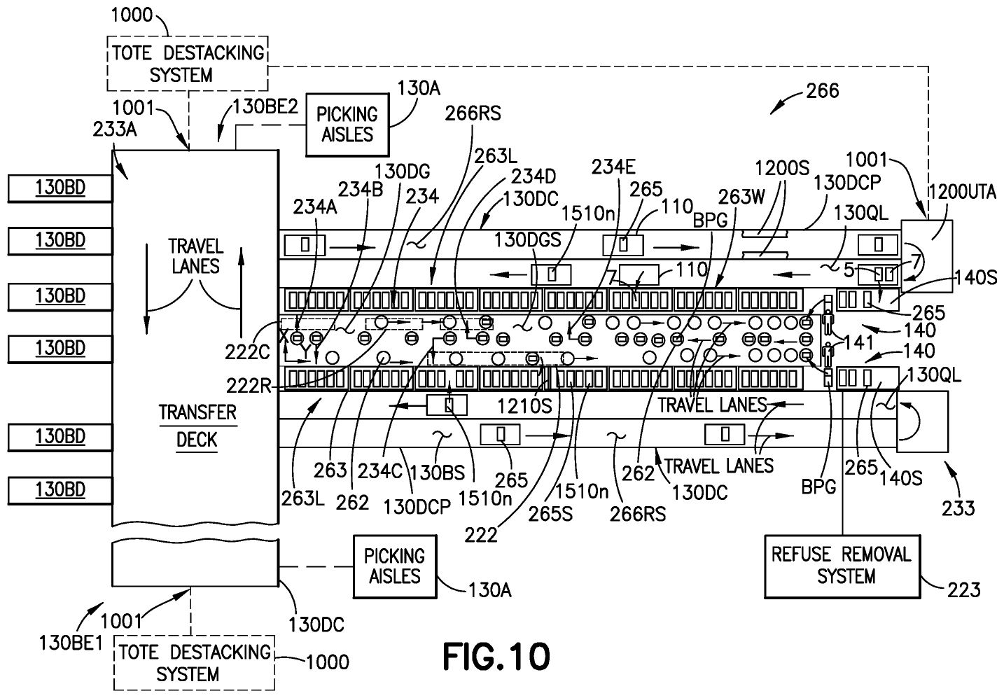

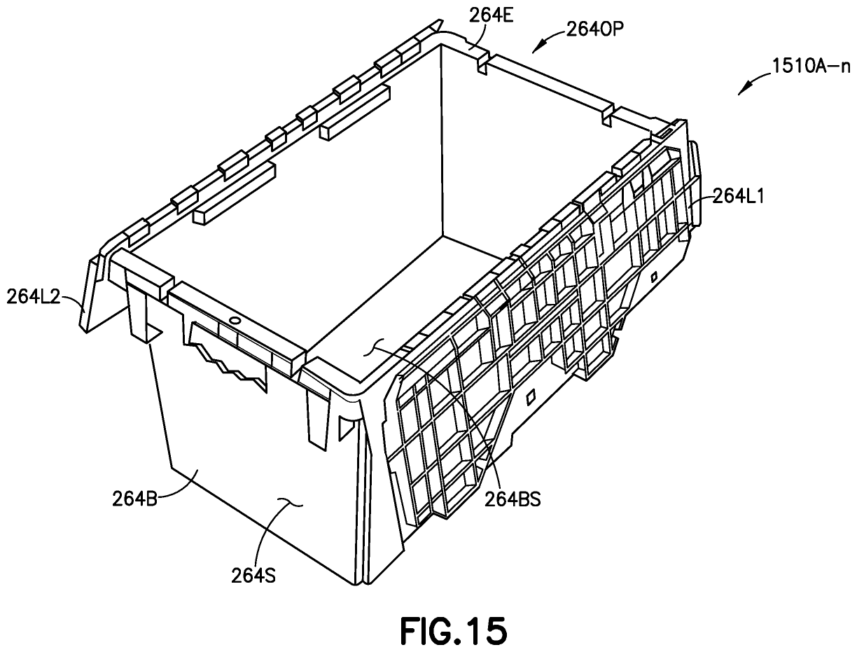

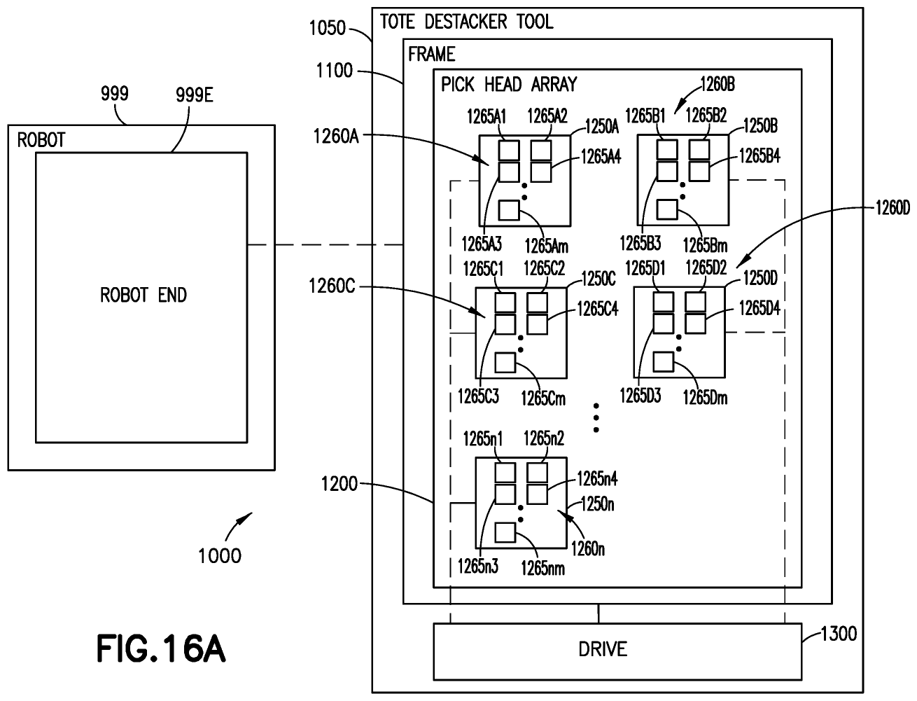

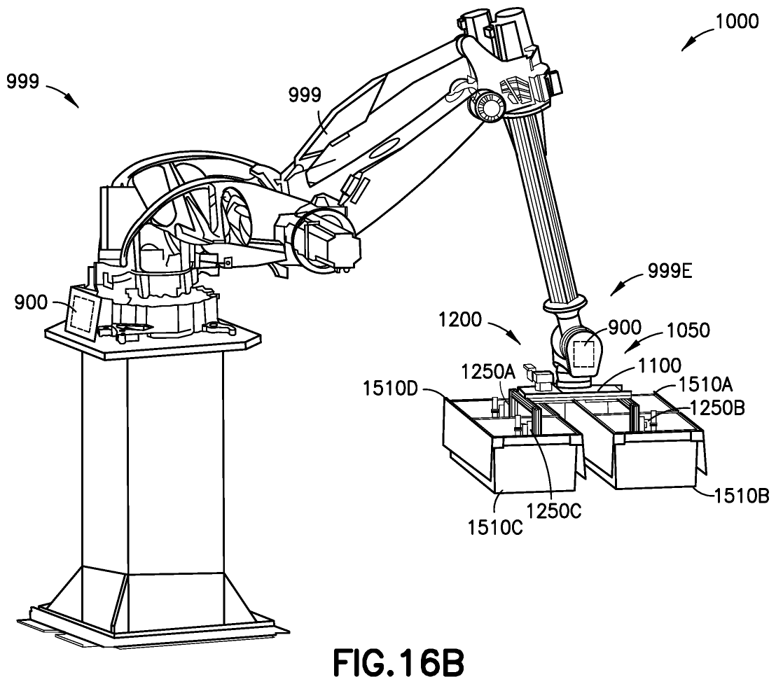

In accordance with the aspects of the disclosed embodiment, the automated storage and retrieval system 100 includes one or more breakpack modules or stations 266 (see FIG. 10). The breakpack modules 266 are configured to break down product containers or case units CU (FIG. 5) into breakpack goods tote(s) 1510A-n (also referred to herein as goods containers or mixed product unit containers; see FIGS. 2 and 15) for order fulfillment. It is noted that although the expression “tote” is used throughout the description, a tote should be construed herein as including any type of tote, container, box, bucket, carton, crate, etc. The breakpack goods tote(s) 1510A-n (referring briefly to FIG. 15) are, for exemplary purposes (although the tote may have any suitable configuration), containers having a bin portion 264B having a bin opening 264OP and a bottom interior surface 264BS, in which goods are placed, and lid portions 264L1, 264L2 that are attached to bin portion 264B by respective hinges. The lid portions 264L1, 264L2 are interlocking lid portions each having a respective superior lock portion and a respective inferior lock portion, which with the lid portions 264L1, 264L2 closed, interlock with each other in a cammed manner to maintain the lid portions 264L1, 264L2 in a closed configuration. Here, product is placed into the breakpack goods tote(s) 1510A-n with automation (as described herein) such that the products are loosely placed. In order to provide the breakpack modules 266 with empty totes, the automated storage and retrieval system 100 includes at least one tote destacking system(s) 1000 (see, e.g., FIGS. 1 and 16) that provides the breakpack modules 266 with the breakpack goods tote(s) 1510A-n for effecting fulfillment of the breakpack goods tote(s) 1510A-n as will be further described herein. The tote destacking system(s) 1000 comprises a robot 999 having an automatic product tote destacker tool 1050. The automatic product tote destacker tool 1050 includes a frame 1100 with a coupling 1110 configured so as to mate the automatic product tote destacker tool 1050 to a robot end 999E of the robot 999 so that the automatic product tote destacker tool 1050 provides the robot 999 with an end effector to denest tote(s) 1510A-n from a stack 1505A-n as will be further described herein.

In some aspects, the automated storage and retrieval system 100 may include (in addition to or in lieu of the breakpack modules 266) one or more each pick modules substantially similar to those described in U.S. Pat. No. 9,037,286 issued on May 19, 2015 (the disclosure of which is incorporated herein by reference), where the breakpack tote(s) 1510A-n are filled by human or robotic operators, where the breakpack tote(s) 1510A-n are input to the each pick modules from the tote destacking system(s) 1000 by the container bots 110 in a manner substantially similar to that described herein with respect to the breakpack modules 266.

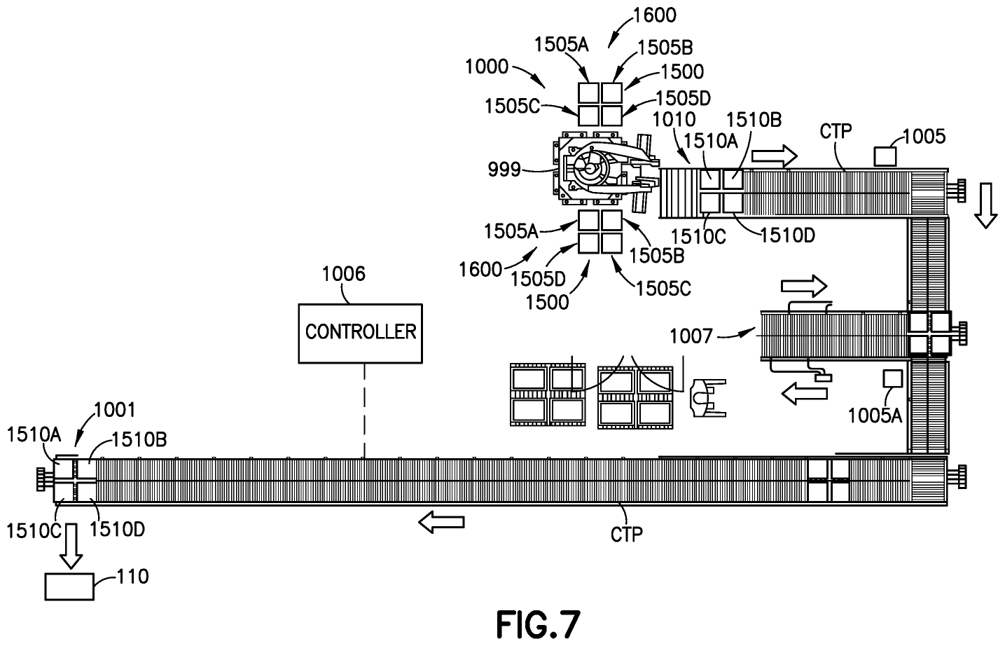

One or more breakpack modules 266 and one or more tote destacking system 1000 for destacking tote(s) 1510A-n from a stack 1505A-n may be located on a common level 130L of the automated storage and retrieval system 100, where one or more levels of the automated storage and retrieval system 100 include at least one breakpack module 266 and at least one tote destacking system 1000. The tote destacking system(s) 1000 may be plug and play module(s) that may be coupled to any suitable portion of the structure of the automated storage and retrieval system 100. For example, the tote destacking system(s) 1000 may be coupled to a container transfer deck 130DC or picking (or pick) aisle(s) 130A of the automated storage and retrieval system 100. The tote destacking system(s) 1000 may be disposed on any suitable number of stacked storage levels of the automated storage and retrieval system 100. Here, the tote destacking system(s) 1000 have a synchronous tote transport or conveyor CTP (as described herein-see FIG. 7) that transports the tote(s) 1510A-n from a robot 999 (having an automatic product tote destacker tool 1050) to an output interface station 1001. From the output interface station 1001, the tote(s) 1510A-n are transferred to breakpack modules 266 (or breakpack put walls such as described in, for example, U.S. patent application Ser. No. 17/657,705 filed on Apr. 1, 2022 and titled “Warehousing System for Storing and Retrieving Goods in Containers,” the disclosure of which is incorporated herein by reference in its entirety) to receive products from “broken” down case units CU. Each tote transport CTP at each respective level 130L of the different levels 130L directs the tote(s) 1510A-n at the respective level 130L to the output interface station 1001. As described herein, the output interface station 1001 is configured to communicate with an asynchronous container transport (as described herein—see FIG. 7) so as to unload the tote(s) 1510A-n from the tote transport CTP to the asynchronous transport at each respective level 130L. In one aspect, the tote transport CTP is in the form of linear conveyors that are adapted to receive the tote(s) 1510A-n placed thereon by the system 1000. In another aspect (not shown), the tote transport CTP is replaced by an output table or any other means adapted to receive the tote(s) 1510A-n, such as directly to an automated guided vehicle (AGV). In still another aspect, two tote transports CTP (or more) or other output means are used.

The automated storage and retrieval system 100 may be configured, such as through any suitable controller (e.g., control server 120) so that the automated storage and retrieval system 100 has selectable modes of operation. In one mode of operation the automated storage and retrieval system 100 is configured to output product cases, containers, and/or case units to a palletizer. In another mode of operation, such as with the breakpack module(s) 266 employed, the automated storage and retrieval system 100 is configured to break down product cases, product containers, and/or case units and output breakpack goods containers, product cases, containers, and/or case units to a palletizer, or in other aspects, re-enter the breakpack (order) container(s) and/or a remainder of a product cases, containers, and/or case units to a palletizer (e.g., after being broken down) into storage for later retrieval. The at least one tote destacking system(s) 1000 is configured to effect automatically denesting stacks 1505A-n of totes 1510A-n prior to transport to the breakpack module(s) 266 to be filled.

The controller 120, as may be realized, is configured to effect operation of a container bot 110 and a goods bot 262 (both of which form at least part of the asynchronous transport system) (see also, e.g., FIG. 10) for assembling orders of breakpack goods BPG from supply containers 265 into the breakpack goods tote(s) 1510A-n and outfeed of breakpack goods tote(s) 1510A-n through container outfeed stations TS. For example, the controller 120 is configured to effect operation of the container bot(s) 110 between at least the container storage locations 130S, the breakpack operation station 140, and the tote destacking system(s) 1000 located along the breakpack goods transfer deck 130DG. As another example, the controller 120 is configured to effect operation of the goods bot(s) 262 so that transport of the breakpack goods BPG, by the goods bot 262 traverse on the goods transfer deck 130DG, sorts the breakpack goods BPG, e.g., in a unit/each level sortation, to corresponding breakpack goods tote(s) 1510A-n. As a further example, the controller 120 is configured to effect operation of the container bot(s) 110 so that the container bot(s) 110 accesses corresponding empty breakpack goods tote(s) 1510A-n from the output interface station 1001 and transports the empty breakpack goods tote(s) 1510A-n for example via traverse along the container transfer deck 130DC or in other aspects along bot lanes adjacent the put wall 263W (FIG. 10), to the breakpack module(s) 266 and from the breakpack module(s) 266, after filling of the tote(s) 1510A-n, to at least one of a container output/transfer station TS and a corresponding storage location 130S of a corresponding level 130L of the multilevel storage array.

Also referring to FIG. 5, it is noted that when, for example, incoming bundles or pallets (e.g., from manufacturers or suppliers of case units arrive at the storage and retrieval system for replenishment of the automated storage and retrieval system 100, the content of each pallet may be uniform (e.g., each pallet holds a predetermined number of the same item-one pallet holds soup and another pallet holds cereal). As may be realized, the cases of such pallet load may be substantially similar or in other words, homogenous cases (e.g., similar dimensions), and may have the same SKU (otherwise, as noted before the pallets may be “rainbow” pallets having layers formed of homogeneous cases). As pallets PAL leave the storage and retrieval system 100, with cases filling replenishment orders, the pallets PAL may contain any suitable number and combination of different case units CU (e.g., each pallet may hold different types of case units-a pallet holds a combination of canned soup, cereal, beverage packs, cosmetics and household cleaners). The cases combined onto a single pallet may have different dimensions and/or different SKU's. In one aspect of the disclosed embodiment, the storage and retrieval system 100 may be configured to generally include an in-feed section, a storage and sortation section (where, in one aspect, storage of items is optional) and an output section as will be described in greater detail below. As may be realized, in one aspect of the disclosed embodiment the system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and assemble the corresponding groups of cases into what may be referred to as mixed case pallet loads MPL. As may also be realized in one aspect of the disclosed embodiment the system 100 operating for example as a retail distribution center may serve to receive uniform pallet loads of cases, breakdown the pallet goods or disassociate the cases from the uniform pallet loads into independent case units handled individually by the system, retrieve and sort the different cases sought by each order into corresponding groups, and transport and sequence the corresponding groups of cases in the manner described in U.S. Pat. No. 9,856,083 issued on Jan. 2, 2018, the disclosure of which is incorporated herein by reference in its entirety.

The storage and sortation section includes, as will be described in greater detail below, a multilevel automated storage system that has an automated transport system that in turn receives or feeds individual cases into the multilevel storage array for storage in a storage area (such as storage spaces 130S of the storage structure 130). The storage and sortation section also defines outbound transport of case units from the multilevel storage array such that desired case units are individually retrieved in accordance with commands generated in accordance to orders entered into a warehouse management system, such as warehouse management system 2500, for transport to the output section. In other aspects, the storage and sortation section receives individual cases, sorts the individual cases (utilizing, for example, buffer and interface stations), e.g., in a case level sortation, and transfers the individual cases to the output section in accordance to orders entered into the warehouse management system. The sorting and grouping of cases according to order (e.g., an order out sequence) may be performed in whole or in part by either the storage and retrieval section or the output section, or both, the boundary between being one of convenience for the description and the sorting and grouping being capable of being performed any number of ways. The intended result is that the output section assembles the appropriate group of ordered cases, that may be different in SKU, dimensions, etc. into mixed case pallet loads in the manner described in, for example, U.S. Pat. No. 8,965,559 issued on Feb. 24, 2015 and titled “Pallet Building System,” the disclosure of which is incorporated herein by reference in its entirety.

In the disclosed embodiment, the output section generates the pallet load in what may be referred to as a structured architecture of mixed case stacks. The structured architecture of the pallet load described herein is representative and in other aspects, the pallet load may have any other suitable configuration. For example, the structured architecture may be any suitable predetermined configuration such as a truck bay load or other suitable container or load container envelope holding a structural load. The structured architecture of the pallet load may be characterized as having several flat case layers L121-L125, L12T as described in U.S. Pat. No. 9,856,083, previously incorporated by reference herein in its entirety.

In accordance with aspects of the disclosed embodiment, referring again to FIG. 1, the automated storage and retrieval system 100 includes a storage array (e.g., storage structure 130 having storage spaces 130S) with at least one elevated storage level 130L. Mixed product units are input and distributed in the storage array in cases CU of product units of common kind per case CU (each case input to the system 100 holds a common kind of stock keeping unit (SKU)). For example, the automated storage and retrieval system 100 includes input stations 160IN (which include depalletizers 160PA and/or conveyors 160CA for transporting items (e.g., inbound supply containers) to lift modules 150A for entry into a storage level 130L of the storage structure 130).

As will be described herein, the automated storage and retrieval system 100 includes an automated transport system (e.g., bots, breakpack modules, tote destacking systems 1000, and other suitable level transports described herein) with at least one asynchronous transport system for transporting cases/products on a given storage structure level 130L (e.g., level transport). For example, the automated storage and retrieval system 100 includes at least one storage level 130L having storage aisles (also referred to herein as picking aisles) 130A and a transport deck (also referred to herein as a container transport deck) 130DC connecting the storage aisles 130A. At least one breakpack station 140 is communicably coupled to the transfer deck 130DC. At least one tote destacking system(s) 1000 is communicably coupled to the transfer deck 130DC by an asynchronous transport system (described herein) and at least one autonomous guided vehicle (also referred to herein as a containers bot) 110 (e.g., of the asynchronous transport system) is configured to traverse the transfer deck 130DC (as describe herein) and transport tote(s) 1510A-n from the at least one tote destacking system(s) 1000 to at least one breakpack station 140.

As will be described herein, the storage and retrieval system 100 includes the undeterministic container bots 110 that travel along one or more physical pathways of the storage and retrieval system to provide at least one level of asynchronicity. At least another level of asynchronicity is provided (as described herein) such that, for example, case/product holding locations are greater than the number of bots transporting cases/products. At least one lift 150 is provided for transporting cases/products between storage levels (e.g., between level transport). The at least one lift 150B is communicably connected to the storage array as described herein so as to automatically retrieve and output, from the storage array, product units distributed in the cases CU in a common part (e.g., the storage locations 130S of a respective storage level 130L) of the at least one elevated storage level 130L of the storage array. The output product units being one or more of mixed singulated product units, in mixed packed groups, and in mixed cases. As an example, the automated storage and retrieval system 100 includes output stations 160UT, 160EC (which include palletizers 160PB, operator stations 160EP and/or conveyors 160CB for transporting items (e.g., outbound supply containers and filled breakpack goods (order) containers) from lift modules 150B for removal from storage (e.g., to a palletizer (for palletizer load) or to a truck (for truck load)). Here the output station 160EC is an individual fulfillment (or e-commerce) output station where, for example, filled breakpack goods (order) containers including single goods items and/or small bunches of goods are transported for fulfilling an individual fulfillment order (such as an order placed over the Internet by a consumer). The output station 160UT is a commercial output station where large numbers of goods are generally provided on pallets for fulfilling orders from commercial entities (e.g., commercial stores, warehouse clubs, restaurants, etc.). As may be realized, the automated storage and retrieval system 100 includes both the commercial output station 160UT and the individual fulfillment output station 160EC; while in other aspects, the automated storage and retrieval system includes one or more of the commercial output station 160UT and the individual fulfillment output station 160EC.

The automated storage and retrieval system 100 also includes the input and output vertical lift modules 150A, 150B (generally referred to as lift modules 150—it is noted that while input and output lift modules are shown, a single lift module may be used to both input and remove case units from the storage structure), a storage structure 130 (which may have at least one elevated storage level as noted above and in some aspects, forms a multilevel storage array), and at least one autonomous container transport vehicle 110 (referred to herein as “container bots” or “autonomous guided vehicles” and which form at least a part of the asynchronous transport system for level transport) which may be confined to a respective storage level of the storage structure 130 and are distinct from a transfer deck 130DC on which they travel. It is noted that the depalletizers 160PA may be configured to remove case units from pallets so that the input station 160IN can transport the items to the lift modules 150 for input into the storage structure 130. The palletizers 160PB may be configured to place items removed from the storage structure 130 on pallets PAL (FIG. 5) for shipping. As used herein the lift modules 150, storage structure 130 and container bots 110 may be collectively referred to herein as the multilevel automated storage system (e.g., storage and sorting section) noted above, which has an integral “on the fly sortation” (e.g., sortation of case units during transport of the case units) so that case unit sorting and throughput occurs substantially simultaneously without dedicated sorters as described in U.S. Pat. No. 9,856,083, previously incorporated herein by reference in its entirety.

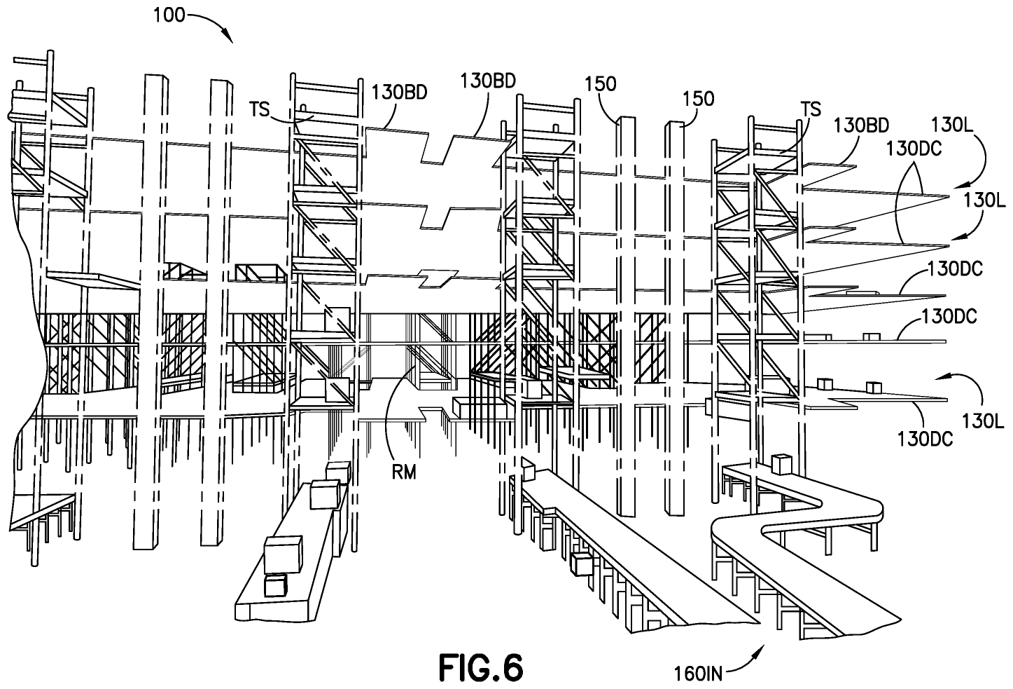

Also referring to FIGS. 1, 6, 8, and 10, the storage structure 130 may include a container autonomous transport travel loop(s) 233, 233A (e.g., formed on and along a container transfer deck 130DC), disposed at a respective level of the storage structure 130. It is noted that the lifts 150 are connected via transfer stations TS (also referred to herein as container infeed stations when the lift 150 is an inbound lift 150A or as container outfeed stations when the lift 150 is an outbound lift 150B) to the container transfer deck 130DC, and each lift is configured to lift one or both of supply containers 265 (empty or filled) (see FIG. 10) and the breakpack goods tote(s) 1510A-n (empty or filled) (see FIG. 10) into and out of the at least one elevated storage level 130L of the storage structure 130. Container storage locations (or spaces) 130S are arrayed peripherally along the container transfer deck 130DC. For example, multiple storage rack modules RM, configured in a high-density three dimensional rack array RMA, are accessible by storage or deck levels 130L. As used herein the term “high density three dimensional rack array” refers to the three dimensional rack array RMA having undeterministic open shelving distributed along picking aisles 130A where, in some aspects, multiple stacked shelves are accessible from a common picking aisle travel surface or picking aisle level as described in U.S. Pat. No. 9,856,083, previously incorporated by reference herein in its entirety.

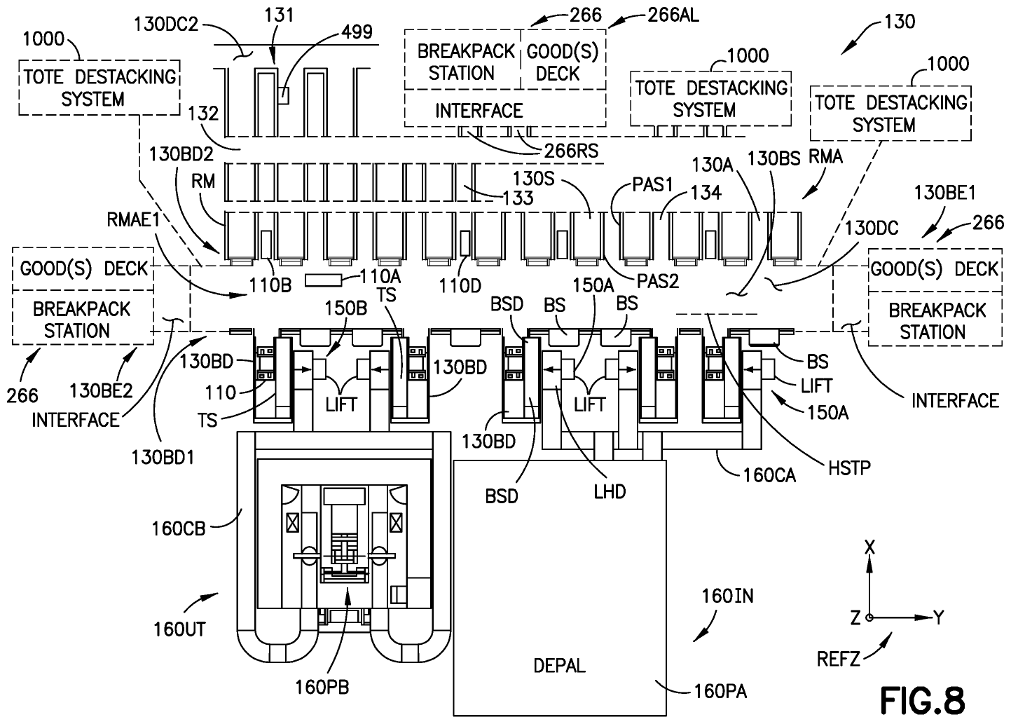

Each storage level includes pickface 130L storage/handoff spaces 130S (referred to herein as storage spaces 130S or container storage locations 130S) arrayed peripherally along the container transfer deck 130DC. The storage spaces 130S are in one aspect formed by the rack modules RM where the rack modules include shelves that are disposed along storage or picking aisles 130A (that are connected to the container transfer deck 130DC) which, e.g., extend linearly through the rack module array RMA and provide container bot 110 access to the storage spaces 130S and transfer deck(s) 130B. In one aspect, the shelves of the rack modules RM are arranged as multi-level shelves that are distributed along the picking aisles 130A. As may be realized the container bots 110 travel on a respective storage level 130L along the picking aisles 130A and the container transfer deck 130DC for transferring case units between any of the storage spaces 130S of the storage structure 130 (e.g., on the level which the container bot 110 is located) and any of the lift modules 150 (e.g., each of the container bots 110 has access to each storage space 130S on a respective level and each lift module 150 on a respective storage level 130L). The transfer decks 130B are arranged at different levels (corresponding to each level 130L of the storage and retrieval system) that may be stacked one over the other or horizontally offset, such as having one container transfer deck 130DC at one end or side RMAE1 (FIG. 8) of the storage rack array RMA or at several ends or sides RMAE1, RMAE2 of the storage rack array RMA as described in, for example, U.S. Pat. No. 10,822,168 issued on Nov. 3, 2020, the disclosure of which is incorporated herein by reference in its entirety.

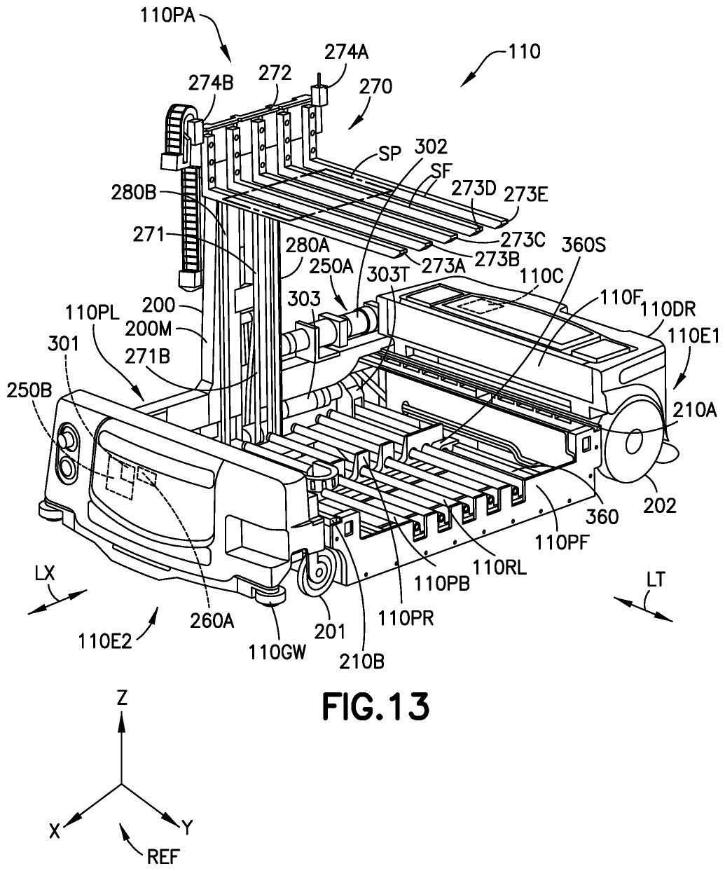

The container transfer decks 130DC are substantially open and configured for the undeterministic traversal of container bots 110 along multiple travel lanes across and along the transfer decks 130B. As described in U.S. Pat. No. 10,556,743 issued on Feb. 11, 2020 and having application Ser. No. 15/671,591 (the disclosure of which is incorporated herein by reference in its entirety) the multiple travel lanes may be configured to provide multiple access paths or routes to each storage location 130S (e.g., pickface, case unit, container, or other items stored on the storage shelves of rack modules RM) so that container bots 110 may reach each storage location using, for example, a secondary path if a primary path to the storage location is obstructed. As may be realized, the transfer deck(s) 130B at each storage level 130L communicate with each of the picking aisles 130A on the respective storage level 130L. Container bots 110 bi-directionally traverse between the container transfer deck(s) 130DC and picking aisles 130A on each respective storage level 130L so as to travel along the picking aisles and access the storage spaces 130S disposed in the rack shelves alongside each of the picking aisles 130A (e.g., container bots 110 may access storage spaces 130S distributed on both sides of each aisle such that the container bot 110 may have a different facing when traversing each picking aisle 130A, for example, referring to FIG. 13, drive wheels 202 leading a direction of travel or drive wheels trailing a direction of travel). As noted above, the container transfer deck(s) 130DC also provides container bot 110 access to each of the lifts 150 on the respective storage level 130L where the lifts 150 feed and remove case units to and/or from each storage level 130L and where the container bots 110 effect case unit transfer between the lifts 150 and the storage spaces 130S.

As described above, referring also to FIG. 8, in one aspect the storage structure 130 includes multiple storage rack modules RM, configured in a three dimensional array RMA where the racks are arranged in aisles 130A. The aisles 130A are configured for container bot 110 travel within the aisles 130A. The container transfer deck 130DC has an undeterministic transport surface on which the container bots 110 travel where the undeterministic transport surface (also referred to herein as a deck surface) 130BS has multiple travel lanes (e.g., more than one juxtaposed travel lane (e.g., high speed bot travel paths HSTP)) for travel of the container bot 110 along the container autonomous transport travel loop(s) 233, 233A formed by the container transfer deck 130DC, where the multiple travel lanes connect the aisles 130A. The container autonomous transport travel loop 233A provides the container bot 110 with random access to any and each picking aisle 130A and random access to any and each lift 150A, 150B on the respective level 130L of the storage structure 130. At least one of the multiple travel lanes has a travel sense opposite to another travel lane sense of another of the multiple travel lanes (so as to form the container autonomous transport travel loop 233).

The storage and retrieval system 100 may include one or more bypass aisles 132 that run substantially transverse to the picking aisles 130 to allow the container bots 110 to move between picking aisles 130 in lieu of traversing the container transfer decks 130DC, 130DC2. The bypass aisles 132 may be substantially similar to travel lanes of the container transfer decks 130DC, 130DC2, as described herein, and may allow bidirectional or unidirectional travel of the container bots through the bypass aisle 132. The bypass aisle 132 may provide one or more lanes of container bot travel where each lane has a floor and suitable guides for guiding the bot along the bypass aisle 132 in a manner similar to that described herein with respect to the transfer decks 130DC, 130DC2. In other aspects, the bypass aisles 132 may have any suitable configuration for allowing the container bots 110 to traverse between the picking aisles 130. It is noted that while the bypass aisle 132 is shown with respect to a storage and retrieval system having transfer decks 130DC, 130DC2 disposed on opposite ends of the storage structure, in other aspects, a storage and retrieval system 100 having only one transfer deck may also include one or more bypass aisles 132.

As described herein, one or more of the breakpack modules 266 and/or tote destacking system(s) 1000 may be disposed in a picking aisle(s) 130A. For example, breakpack module 266AL may be located on a side of the container transfer deck 130DC on which the picking aisles 130A are located and one or more picking aisles 130A extend into the breakpack module 266AL so as to form container bot riding surface(s) 266RS. A tote destacking system(s) 1000 may be located on a side of the container transfer deck 130DC on which the picking aisles 130A of with tote output 1001 adjacent bot lanes of put wall 263W (FIG. 10) are located and one or more picking aisles 130A extend into the tote destacking system(s) 1000 so as to form container bot riding surface(s). Where the container bot 110A is to deliver a supply container 265 to the breakpack module 266AL or a breakpack tote(s) 1510A-n from the tote destacking system(s) 1000 and the picking aisle 133 extending into the breakpack module or the picking aisle 134 extending into the tote destacking system(s) 1000 is blocked by a container bot 110D, the bypass aisle 132 may be employed to provide a secondary or alternative route for the container bot 110 to transport the supply container 265 to the breakpack module 266AL or the breakpack tote(s) 1510A-n from the tote destacking system(s) 1000.

It is noted that the storage and retrieval systems shown and described herein have exemplary configurations only and in other aspects, the storage and retrieval systems may have any suitable configuration and components for storing and retrieving items as described herein. For example, in other aspects, the storage and retrieval system may have any suitable number of storage sections, any suitable number of transfer decks, any suitable number of breakpack modules, and corresponding input/output stations.

As may be realized, the juxtaposed travel lanes are juxtaposed along a common undeterministic transport surface 130BS between opposing sides 130BD1, 130BD2 of the container transfer deck 130DC. As illustrated in FIG. 8, in one aspect the aisles 130A are joined to the container transfer deck 130DC on one side 130BD2 of the container transfer deck 130DC but in other aspects, the aisles are joined to more than one side 130BD1, 130BD2 of the container transfer deck 130DC in a manner substantially similar to that described in U.S. Pat. No. 10,822,168 issued on Nov. 3, 2020, the disclosure of which is previously incorporated by reference herein in its entirety. As will be described in greater detail below the other side 130BD1 of the container transfer deck 130DC may include deck storage racks (e.g., interface stations (also referred to as transfer stations) TS and buffer stations BS) that are distributed along the other side 130BD1 of the container transfer deck 130DC so that at least one part of the transfer deck is interposed between the deck storage racks (such as, for example, buffer stations BS or transfer stations TS) and the aisles 130A. The deck storage racks are arranged along the other side 130BD1 of the container transfer deck 130DC so that the deck storage racks communicate with the container bots 110 from the container transfer deck 130DC and with the lift modules 150 (e.g., the deck storage racks are accessed by the container bots 110 from the container transfer deck 130DC and by the lifts 150 for picking and placing pickfaces so that pickfaces are transferred between the container bots 110 and the deck storage racks and between the deck storage racks and the lifts 150 and hence between the container bots 110 and the lifts 150).

Referring again to FIG. 1, each storage level 130L may also include charging stations 130C for charging an on-board power supply of the container bots 110 on that storage level 130L such as described in, for example, U.S. patent application Ser. No. 14/209,086 filed on Mar. 13, 2014 and U.S. Pat. No. 9,082,112 issued on Jul. 14, 2015, the disclosures of which are incorporated herein by reference in their entireties.

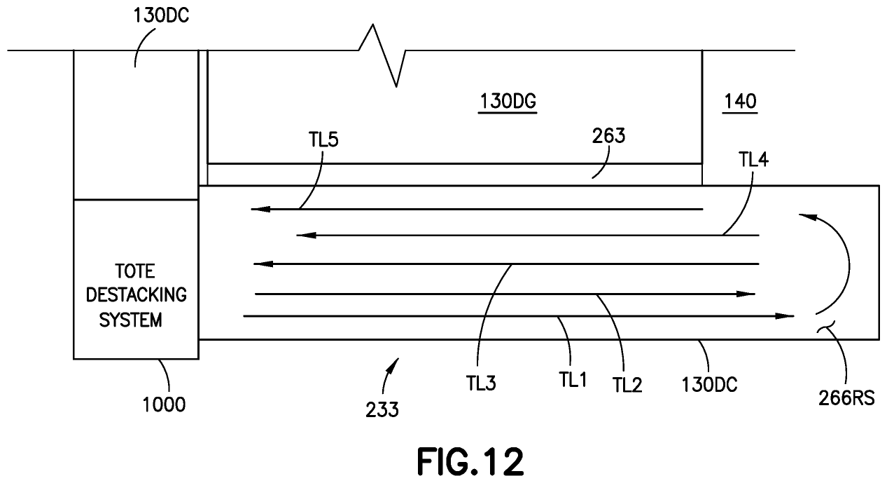

Referring to FIGS. 1, 8, 10, as noted above, the automated storage and retrieval system 100 includes one or more break pack modules 266. In one aspect, each breakpack module 266 has a container bot riding surface 266RS that forms a portion 130DCP of the container transfer deck 130DC, where the riding surface 2666RS is substantially similar to that of container transfer deck 130DC, while in other aspects, the container bot riding surface 266RS may be substantially similar to that of the picking aisles 130A. For ease of explanation, the aspects of the disclosed embodiment will refer to the container bot riding surface 266RS within the breakpack module 266 as a portion of the container transfer deck 130DC. In aspects where the bot riding surface 266RS is formed by a portion of (or is an extension of) the container transfer deck 130DC it is noted that, while the container transfer deck 130D is illustrated in FIG. 10 a single path transport loop and in other aspects, the transport loop of the breakpack module 266 may be a multilane transport loop substantially similar to container transport deck illustrated in FIG. 8. For example, referring to FIG. 12 the container bot travel surface 266RS is an open undeterministic travel surface having multiple travel inbound and outbound lanes. For example, there are multiple inbound travel lanes TL1, TL2 where travel lane TL2 is a bypass lane for travelling around obstructions on travel lane TL1 (or vice versa). There may also be multiple outbound travel lanes TL3, TL4, TL5. Here, travel lane TL5 defines a queue lane 130QL (FIG. 10) for the container bots 110 at the breakpack goods interface 263 while travel lanes TL4 and TL5 may be used for egress from the breakpack module 266, with travel lane TL5 being a bypass for travelling around obstructions on travel lane TL4 (or vice versa).

Each of the breakpack modules 266 includes a breakpack goods autonomous transport travel loop 234 (see exemplary breakpack goods autonomous transport travel loops 234A-234E formed on and along a goods deck or goods transfer deck 130DG), at least one breakpack operation station 140, and a breakpack goods interface 263 disposed between and interfacing the goods transfer deck 130DG with the container transfer deck 130DC. For exemplary purposes only, the goods deck 130DG is illustrated as having three travel lanes that form the (variable length) travel loops 234A-234E; however, in other aspects, the goods deck may have any suitable number of travel lanes that form any suitable number of breakpack goods autonomous transport travel loops 234. Each breakpack module 266 may be undeterministically coupled (e.g., the breakpack modules 266 maybe coupled to the automated storage and retrieval system 100 at any suitable location thereof, such as to one or more ends 130BE1, 130BE2, or centrally located between the two ends 130BE1, 130BE2 such as in place of picking aisles 130 (and storage locations) or at any other suitable location) to the automated storage and retrieval system 100 in any suitable manner (e.g., so as to form a part thereof). Though the breakpack modules 266 are coupled undeterministically to the structure of the automated storage and retrieval system 100 each component of the breakpack modules 166 is independent (e.g., self-contained as a unit) and/or independently automated in guidance and travel of the bots (e.g., goods bots 262) from the components of the automated storage and retrieval system, so that the interface between the components of the breakpack modules 266 and the components of the automated storage and retrieval system 100 is undeterministic.

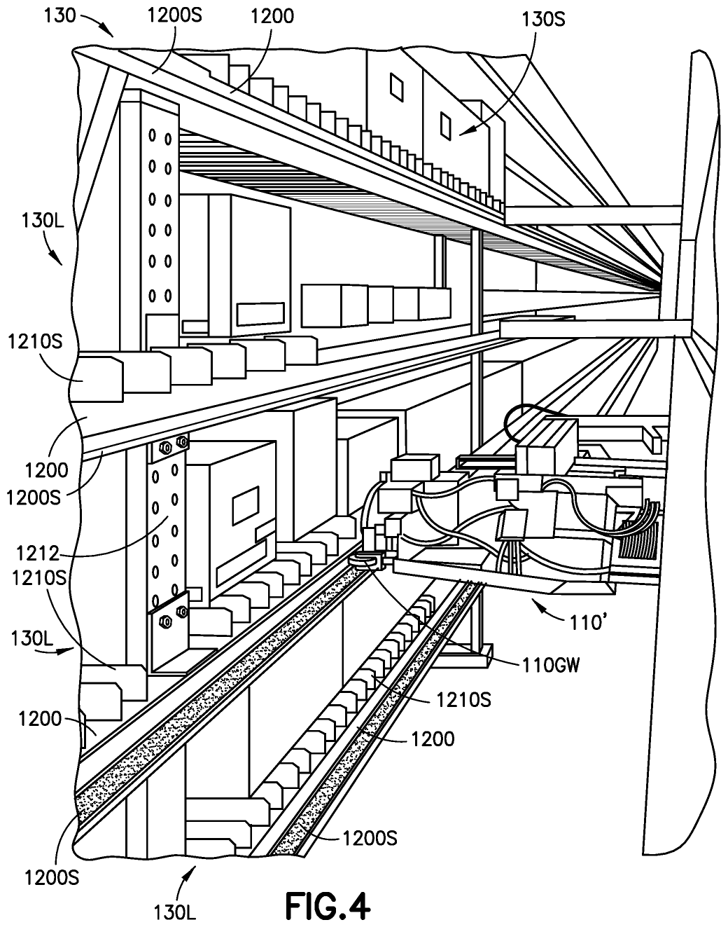

The breakpack module(s) 266 may be coupled to the structure of the automated storage and retrieval system 100 at any suitable location and at any suitable level(s) 130L. For example, as noted above, a break pack module 266 may be located at one or more ends 130BE1, 130BE2 of the container transfer deck 130DC or at one or more sides 130BD1, 130BD2 of the container transfer deck 130DC (such as in lieu of storage rack modules RM/picking aisles 130A or lifts 150A, 150B, or as an extension of one or more picking aisles 130A). Each of the breakpack modules 266 is a plug and play module that is integrated with (or otherwise connected to) the container transfer deck 130DC so that the container transfer deck 130DC is communicably coupled to the container bot riding surface 266RS. In one aspect, the container transfer deck 130DC extends into the breakpack module to form the container bot riding surface 266RS (e.g., the breakpack module forms a modular part of the container transfer deck 130DC) so that container bots 110 traverse or move into and out of the breakpack modules 266 along the undeterministic container transfer deck 130DC, and at least one of the multiple travel lanes of the container transfer deck 130DC defines a queue lane 130QL (FIG. 10) for the container bots 110 at the breakpack goods interface 263. In one aspect, the output interface station 1001 communicates with the container bot riding surface 266RS so that the asynchronous container transport (container bot 110) so as to unload the tote(s) 1510A-n from the tote transport CTP to the asynchronous transport. In other aspects, the container bot riding surface 266RS includes rails 1200S (see FIG. 4) that extend from the container transport deck 130DC in a manner similar to that of the picking aisles 130A, so that container bots 110 traverse or move into and out of the breakpack modules 266 along the rails 1200S, and the rails 1200S defines a queue lane 130QL (FIG. 10) for the container bots 110 at the breakpack goods interface 263. It is noted that where the container bot riding surface 266RS is formed by rails 1200S the riding surface may include an undeterministic turn around area 1200UTA (that is similar to the open undeterministic container transfer deck 130DC) on which the container bots 110 turn to transition between different travel portions (e.g., inbound and outbound) of the breakpack goods autonomous transport travel loop 234. As can be seen in FIG. 10, the container bot travel surface 266RS of the breakpack module 266 forms a travel loop 233 around which the container bots 110 travel to respectively transport along the container bot travel surface 266RS travel loop 233 a supply container (e.g., case unit, pickface, remainder container, etc.) between the storage locations 130S and a breakpack operation station 140 (and/or vice versa), and a breakpack goods container (also referred to as a breakpack container) 264 between the breakpack goods interface 263 and the container storage locations 130S or a lift 150A (and/or vice versa). The travel loop 233 provides the container bot 110 with random access to any and each breakpack goods interface locations 263L of the breakpack goods interface 263 along the bot travel surface 266RS, where the breakpack goods interface locations 263L form an asynchronous product distribution system.

The goods transfer deck 130DG forms a goods autonomous transport travel loop 234 disposed at the storage level 130L. The goods transfer deck 130DG is separate and distinct from the travel loop 233 formed by the container bot travel surface 266RS, and has the breakpack goods interface 263 coupling respective edges of the container autonomous transport travel loop 233 of the container transfer deck 130DC and the breakpack goods autonomous transport travel loop 234 of the goods transfer deck 130DG. The goods autonomous transport travel loop 234 formed by the goods transfer deck 130DG is disposed on a deck surface 130DGS of a deck (e.g., goods transfer deck 130DG) at a respective storage level 130L, and the breakpack goods autonomous transport travel loop(s) 234 of the goods transfer deck 130DG is disposed on a different deck surface 130DGS of the deck (e.g., goods transfer deck 130DG), separate and distinct from the deck surface 130BS of the container bot travel surface 266RS (formed by the container transfer deck 130DC and/or rails 1200S) where the container autonomous transport travel loop 233 is disposed. The breakpack goods autonomous transport travel loop 234 formed by the goods transfer deck 130DG (and hence the goods travel deck 130DG) is disposed to confine at least one autonomous breakpack goods transport vehicle (also referred to as goods bots, or goods transport vehicles) 262 to the respective storage level 130L. The at least one goods bot 262 is arranged or otherwise configured for transporting, along the breakpack goods autonomous transport travel loop 234 formed by the goods transfer deck 130DG, one or more breakpack goods BPG (e.g., a pack that is unpacked from the supply container in a pack level sort or a unit/each unpacked from a pack in a unit/each level sort) between the breakpack operation station 140 and the breakpack goods interface 263. The container bot(s) 110 is also configured to autonomously pick and place the breakpack goods tote(s) 1510A-n at the breakpack goods interface 263 as described herein. The breakpack goods interface 263 may be substantially similar to one or more of the transfer stations TS and buffer stations BS described herein and include an undeterministic surface (similar to that of the rack storage spaces 130S described herein) upon which breakpack goods tote(s) 1510A-n are placed so as to form an undeterministic interface between the goods transfer deck 130DG and the container transfer deck 130DC.

In one aspect, the goods transfer deck 130DG facilitates a decanting process where goods are picked from one container (such as a supply container 265 or any other suitable standardized container 265S) at the breakpack operation station 140 and consolidated with goods (generally of the same type) in another (e.g., outbound as noted below) supply container 265 or standardized container 265S at the breakpack goods interface 263, where the other supply container 265 or standardized container 265S is returned to storage. Generally, supply containers 265 inbound to the breakpack modules 266 are picked until empty but only some (not all) of the goods from the inbound supply container may be decanted. Here, what may be referred to as outbound (i.e., outbound from the breakpack modules 266) supply containers 265 or standardized containers 265S (such as totes, trays, etc.) may also be placed on the breakpack goods interface 263 by the container bot(s) 110 in a manner similar to that described herein for the breakpack goods tote(s) 1510A-n to facilitate the decanting process. In the decanting process, goods are removed from a supply container 265 (which may be an original product/good(s) case packaging) at the breakpack operation station 140 and consolidated into the outbound supply container(s) 265 or standardized container 265S (e.g., having the same type of goods as those being removed at the breakpack operation station 140) located on the breakpack goods interface 263. Consolidation of goods having the same type from multiple supply containers 265 into a lesser number of supply containers 265 (and then returned to storage by the container bot(s) 110) may increase the storage density of the automated storage and retrieval system 100 as the supply containers 265 stored in the storage racks can be maintained in a substantially “full” state (rather than having multiple containers that are less than full with the same type of goods therein. In some aspects, the decanted goods (in the standardized container or outbound supply container) are output from the storage and retrieval system 100 via the lifts 150 to be palletized as part of a pallet load (such as at output station 160UT) or to be shipped individually (such as at output station 160EC).

The goods bots 262 may be any suitable type of autonomously guided bot with a payload configured for holding breakpack goods, not product containers (e.g., case units, pickfaces, etc.). Each of the goods bots 262 has a payload hold configured dissimilar from a payload hold of the container bot 110. The goods bots 262 are configured to autonomously travel unconstrained along and across the breakpack goods autonomous transport travel loop(s) 234 formed by the goods deck 130DG. The goods bots 262 are configured so as to automatically unload one or more breakpack goods BPG (retrieved from the breakpack operation station 140) from the goods bot 262 to breakpack goods tote(s) 1510A-n at the breakpack goods interface 263. Suitable examples of goods bots 262 are those produced by Tompkins International of Raleigh, North Carolina (United States), see for example, U.S. Pat. No. 10,248,112 issued on Apr. 2, 2019. The breakpack goods autonomous transport travel loop(s) 234 formed by the goods deck 130DG has multiple travel lanes (see FIG. 10) for travel of the goods bots 262 along the breakpack goods autonomous transport travel loop(s) 234 (see, e.g., travel loops 234A-234E) formed by the goods deck 130DG. As noted herein, three travel lanes are illustrated for exemplary purposes only and in other aspects, there may be more or less than three travel lanes. At least one of the multiple travel lanes is a passing lane for the goods bot 262 travel passing an obstruction on another of the multiple travel lanes in a manner similar to that described herein with respect to the multiple travel lanes of the container transfer deck 130DC. The breakpack goods autonomous transport travel loop(s) 234 provide the goods bots 262 with random access to any and each of the breakpack goods interface locations 263L of the breakpack goods interface 263.

One or more portions of the goods transfer deck 130DG (such as adjacent the breakpack goods interface locations 263L) can be, in one or more aspects, reserved to provide an exit (or off) ramp or entrance (or on) ramp from or to a travel loop travel 234A-234E to effect a transfer of breakpack goods BPG to or from the breakpack goods tote(s) 1510A-n (or supply containers 265, 265S) at the breakpack goods interface locations 263L. Exit ramps (referred to herein as ramps 222, 222C, 222R) will be described herein but it should be understood that the entrance ramps are substantially opposite in direction to the exit ramps 222, 222C, 222R (e.g., provide access to rather than access from a travel loop). One or more ramps 222, 2220, 333R are provided depending on, for example, bot 110 kinematics (velocity, direction, etc.) and location(s) of (destination) breakpack goods interface locations 263L (e.g., near corners of the goods transfer deck 130DG, away from the corners of the goods transfer deck 130DG, etc.) being accessed by the goods bots 262. For exemplary purposes only, ramp 222 is a generic depiction of an on/off ramp that may be located anywhere on the goods transfer deck 130DG and have any suitable length. Ramp 222C is located in a corner of the goods transfer deck 130DG. Ramp 222R is a “rolling” ramp that moves to follow a path of a goods bot 262 traveling along the ramp 222R,

The ramps 222, 222C, 222R (both on and off ramps) may be “closed” temporarily from general access by the goods bots 262 (e.g., only predetermined goods bots delivering breakpack goods to and from the breakpack goods interface locations 263L within the areas designated by the ramps 222, 222C, 222R have access to respective on and off ramps). Generally, the ramps 222, 222C, 222R provide passage to and from a passing lane to a destination breakpack goods interface location 263L. Each ramp 222, 222C, 222R may be bidirectional (such as where a goods bot 2662 enters the ramp and travels in one direction along the ramp to pick or place a breakpack good BPG and then travels in the opposite direction along the ramp to exit from the ramp). In another aspect, the ramp may be a “counter-flow ramp” where travel along a ramp 222, 222C, 222R is in a generally opposing direction to a travel direction around one or more of the travel loop(s) 234 (e.g., a goods bot 262 exits the travel loop and travels in the generally opposing direction along the ramp 222, 222C, 222R). Where the ramp 222, 222C, 222R is an off ramp, the ramp 222, 222C, 222R may terminate at the destination breakpack goods interface location 263L. Similarly, where the ramp 222, 222C, 222R is an on ramp, the ramp 222, 222C, 222R may begin at the destination breakpack goods interface location 263L. As noted above, the ramps 222, 222C, 222R may be located anywhere on the goods transfer deck 130DG such that ramp entry locations vary in what may be referred to as a parking lane (e.g., a lane or a portion of a travel loop in which the goods bot stops to pick or place breakpack goods BPG) based on one or more of bot kinematics and locations of available breakpack goods interface locations 263L. It is noted that while the turns of the goods bots 262 to and from the ramps 222, 222C, 222R are illustrated as being substantially 90° turns, in other aspects, the turns may have an “S” shape similar to that described in U.S. patent application Ser. No. 16/144,668 filed on Sep. 27, 2018 and titled “Storage and Retrieval System”, the disclosure of which is incorporated herein by reference in its entirety.

The ramps 222, 222C, 222R are dynamically generated and may be dynamically effected (e.g., a “rolling” ramp, such as ramp 222R) so that the ramp “rolls” in a progressive fashion with an initial ramp length generated from goods bot entry with adequate clearance for goods bot collision avoidance. In one or more aspects, the ramp 222, 222C 222R is initiated (at bot entry) given that the ramp to the destination breakpack goods interface location 263L is “blocked” (or otherwise obstructed) by an active goods bot 262/active breakpack goods interface location 263L but the blockage is expected to clear before the goods bot 262 traveling along the ramp reaches the blockage. In one or more aspects, if the blockage to the ramp 222, 222C, 222R clears, the ramp 222, 222C, 222R is extended to the destination breakpack goods interface location 263L; however, if the blockage does not clear the goods bot 262 travelling along the ramp 222, 222C, 222R is redirected to, for example, a passing lane and a new ramp is calculated/determined so that the goods bot 262 can place breakpack goods BPG at the destination breakpack goods interface location 263L or another destination breakpack goods interface location 263L.

Referring also to FIG. 13, the breakpack operation station 140 is configured so that one or more breakpack goods BPG are unpacked from supply container(s) 265 at the breakpack operation station 140, and at least one goods bot 262 is configured so as to be loaded with the one or more breakpack goods BPG at the breakpack operation station 140. The breakpack operation station 140 includes any suitable supply container 265 support surface 140S. In one aspect, the support surface 140S is an undeterministic surface substantially similar to that of the storage shelves described herein and include slats 1210S that form the support surface 140S. In other aspects, the support surface 140S may be an undeterministic roller conveyor (powered or unpowered), having rollers 140RL with an arrangement similar to rollers 110RL (see FIGS. 4A and 4B) of the container bot 110 described herein so that tines 273A-273E of the pick head 270 of the container bot 110 (FIGS. 4A and 4B) are interdigitated with the rollers of the roller conveyor for placing (or picking) supply containers 265 to (or from) the support surface 140S. Here, the container bot 110 is configured to autonomously transfer the supply container(s) 265 from the container bot 110 to the breakpack operation station 140 (such as to the support surface 140S) in the manner described herein. The support surface 140S may be configured so that as the supply containers 265 are placed by the container bot 110 the supply containers 265 move along the support surface 140S towards an operator 141 (e.g., a human operator or any suitable robotic operator (e.g., articulated arm, gantry, etc.)) for picking of breakpack goods BPG from the supply containers 265 and placement of the picked breakpack goods to goods bots 262 or to one or more of standardized containers 265S (such as totes, trays, etc.) and breakpack goods tote(s) 1510A-n located at an operator staging area 140A in any suitable manner to effect one or more of a pack level sortation of goods or a unit/each level sortation of goods. The supply containers 265 may be moved along the support surface 140S to a respective operator staging area 140A where the operator 141 picks the breakpack goods BPG from the supply containers 265 for placement in a goods bot 262 or in another container 265S, 264. In one aspects, the operator staging area 140A may be contiguous with and/or formed by the support surface 140S. As described herein, supply cases 265 with remaining goods therein after breakpack is performed may be picked by the container bots 110 from the support surface 140S or staging area 140A and returned to storage or to a lift 150. Empty supply containers 265 may be removed from the support surface 140S or staging area 140A by the operator 141 and stored at the breakpack operation station 140 for later removal in any suitable manner. In one or more aspects, container bots 110 may transport empty containers from the storage and retrieval system via the lifts 150. In one or more aspects, the breakpack operation station 140 includes any suitable refuse removal system 223 for removing refuse (or trash, e.g., shrink wrapping, packaging, boxes, etc.) from the storage and retrieval system. In one or more aspects, the refuse removal system 223 includes one or more of chutes, conveyors, lifts, or any other suitable transport configured to move refuse to a predetermined location; while in other aspects, the refuse may be placed in containers and removed from the storage and retrieval system by the container bots 110 via the lifts 150. As can be seen in FIGS. 10 and 13, the breakpack goods transfer deck 130DG joins the breakpack operation station 140 and the container transfer deck 130DC at a separate location (e.g., at the breakpack goods interface locations 263L) from each access of the container transfer deck 130DC to the breakpack operation station 140 (e.g., at the common support surface 140S) for the container bot 110.

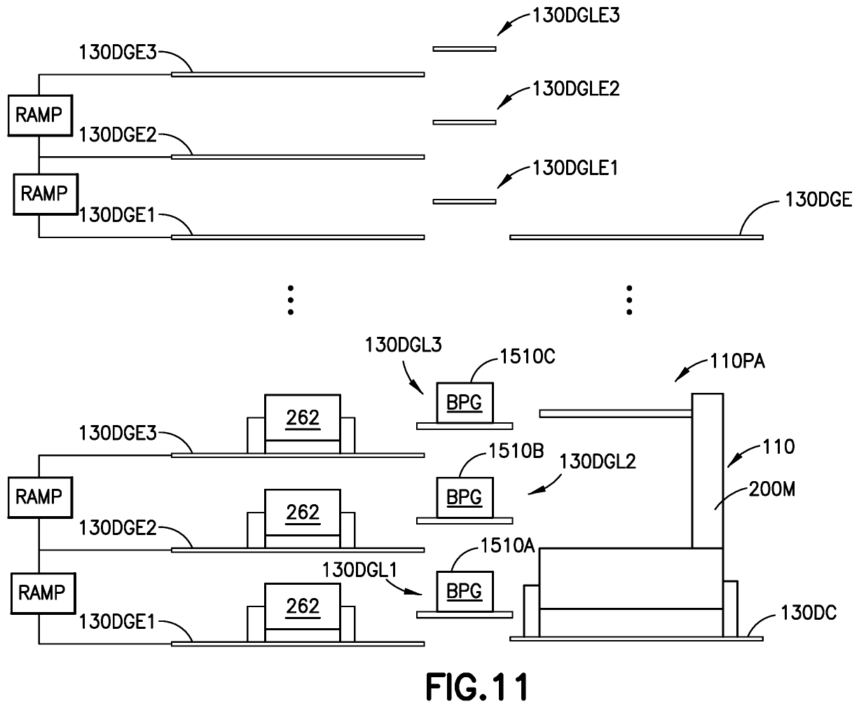

In one aspect, referring also to FIG. 11, one or more of the breakpack modules 266 includes two or more (i.e., multiple levels) goods transfer decks 130DG1-130DG3 stacked one above the other; however, in other aspects the breakpack module(s) may have a single level where an elevated level of at least one breakpack module is connected to a container transfer deck level. Here the breakpack goods interface 263 may be substantially similar to the racks as shown in FIG. 2 and include multilevel levels 130DGL1-130DGL3 that are each accessible from a common (level) container transfer deck 130DC. The container bots 110 may be any suitable independently operable autonomous transport vehicles that carry and transfer case units along the X and Y throughput axes throughout the storage and retrieval system 100. In one aspect the container bots 110 are automated, independent (e.g., free riding) autonomous transport vehicles. Suitable examples of bots can be found in, for exemplary purposes only, U.S. Pat. No. 10,822,168 issued on Nov. 3, 2020; U.S. Pat. No. 8,425,173 issued on Apr. 23, 2013; U.S. Pat. No. 9,561,905 issued on Feb. 7, 2017; U.S. Pat. No. 8,965,619 issued on Feb. 24, 2015; U.S. Pat. No. 8,696,010 issued on Apr. 15, 2014; U.S. Pat. No. 9,187,244 issued on Nov. 17, 2015; U.S. Pat. No. 11,078,017 issued on Aug. 3, 2021; U.S. Pat. No. 9,499,338 issued on Nov. 22, 2016; U.S. Pat. No. 10,894,663 issued on Jan. 19, 2021; and U.S. Pat. No. 9,850,079 issued on Dec. 26, 2017, the disclosures of which are incorporated by reference herein in their entireties. The container bots 110 (described in greater detail below) may be configured to place case units, such as the above described retail merchandise, into picking stock in the one or more levels of the storage structure 130 and then selectively retrieve ordered case units.

The pickfaces (which in one aspect include supply containers 265) are transported between an inbound section of the storage and retrieval system 100, where pickfaces inbound to the array are generated (such as, for example, input station 160IN) and a load fill section of the storage and retrieval system 100 (such as for example, output station 160UT or output station 160EC), where outbound pickfaces from the array are arranged to fill a load in accordance with a predetermined load fill order sequence or an individual fulfillment order(s) in accordance with a predetermined individual fulfillment order sequence. In another aspect, pickfaces (e.g., of supply containers 265) are transported between the storage spaces 130S and a load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence. In still other aspects, breakpack goods tote(s) 1510A-n (which, in one aspect, multiple breakpack goods containers may be arranged in and transported as a pickface) are transported between the storage spaces 130S and the load fill section and/or between the breakpack goods interface 263 of the breakpack module(s) 266 and the load fill section of the storage and retrieval system 100 (such as for example, output station 160UT or output station 160EC) to fill a load in accordance with a predetermined load fill order sequence or an individual fulfillment order(s) in accordance with a predetermined individual fulfillment order sequence.

The container bots 110, lift modules 150 and other suitable features of the storage and retrieval system 100 are controlled in any suitable manner such as by, for example, one or more central system control computers (e.g., control server) 120 through, for example, any suitable network 180. In one aspect the network 180 is a wired network, a wireless network or a combination of wireless and wired networks using any suitable type and/or number of communication protocols. In one aspect, the control server 120 includes a collection of substantially concurrently running programs system (e.g., management software) for substantially automatic control of the automated storage and retrieval system 100. The collection of substantially concurrently running programs, for example, being configured to manage the storage and retrieval system 100 including, for exemplary purposes only, controlling, scheduling, and monitoring the activities of all active system components, managing inventory (e.g., which case units are input and removed, the order in which the cases are removed and where the case units are stored) and pickfaces (e.g., one or more case units that are movable as a unit and handled as a unit by components of the storage and retrieval system), and interfacing with a warehouse management system 2500. The control server 120 may, in one aspect, be configured to control the features of the storage and retrieval system in the manner described herein. For simplicity and ease of explanation, the term “case unit(s)” is generally used herein for referring to both individual case units and pickfaces (a pickface is formed of multiple case units that are moved as a unit).

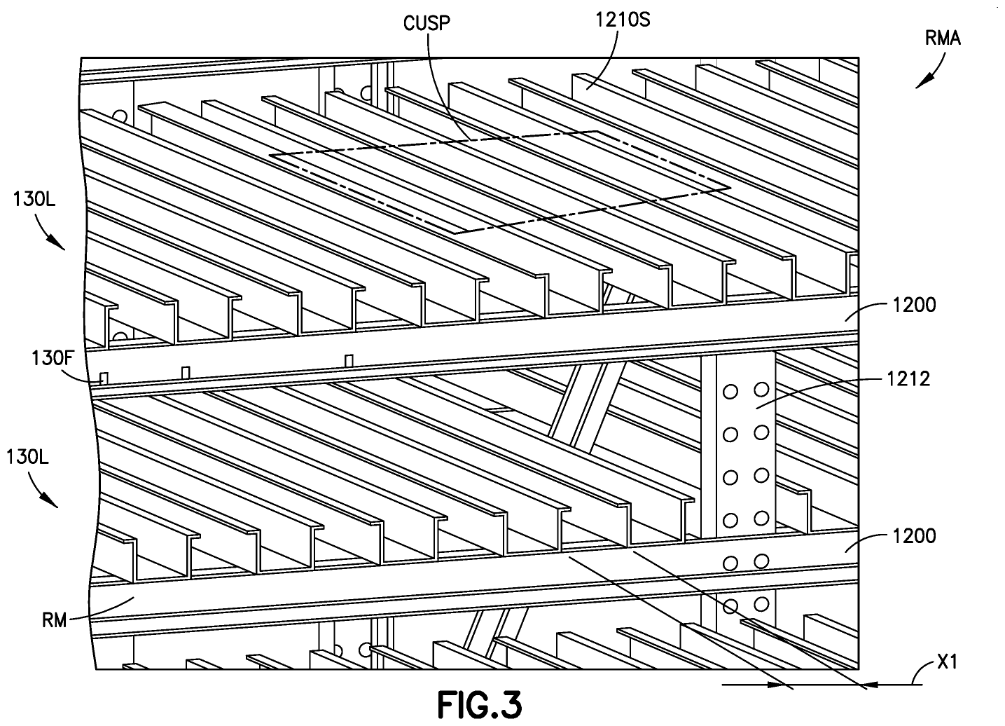

Referring also to FIGS. 2 and 3 the rack module array RMA of the storage structure 130 includes vertical support members 1212 and horizontal support members 1200 that define the high density automated storage array as will be described in greater detail below. Rails 1200S may be mounted to one or more of the vertical and horizontal support members 1212, 1200 in, for example, picking aisles 130A and be configured so that the container bots 110 ride along the rails 1200S through the picking aisles 130A. At least one side of at least one of the picking aisles 130A of at least one storage level 130L may have one or more storage shelves (e.g., formed by rails 1210, 1200 and slats 1210S). In one aspect the one or more shelves may be provided at differing heights so as to form multiple shelf levels 130LS1-130LS3 between the storage or deck levels 130L defined by the transfer decks 130B (and the rails 1200S which form an aisle deck). Accordingly, there are multiple rack shelf levels 130LS1-130LS3, corresponding to each storage level 130L, extending along one or more picking aisles 130A communicating with the container transfer deck 130DC of the respective storage level 130L. As may be realized, the multiple rack shelf levels 130LS1-130LS3 effect each storage level 130L having stacks of stored case units/supply containers 265 (or case layers) and/or stacks of stored breakpack goods tote(s) 1510A-n (or breakpack layers) that are accessible from a common deck 1200S of a respective storage level 130L (e.g., the stacks of stored cases are located between storage levels).

As may be realized, container bots 110 traversing a picking aisle 130A, at a corresponding storage level 130L, have access (e.g., for picking and placing case units and/or breakpack goods containers) to each storage space 130S that is available on each shelf level 130LS1-130LS3, where each shelf level 130LS1-130LS3 is located between adjacent vertically stacked storage levels 130L on one or more side(s) PAS1, PAS2 (see e.g., FIG. 8) of the picking aisle 130A. As noted above, each of the storage shelf levels 130LS1-130LS3 is accessible by the container bot 110 from the rails 1200 (e.g., from a common picking aisle deck 1200S that corresponds with a container transfer deck 130DC on a respective storage level 130L). As can be seen in FIGS. 2 and 3 there are one or more intermediate shelf rails 1210B, 1210C vertically spaced (e.g., in the Z direction) from one another (and from rails 1200) to form multiple stacked storage spaces 130S each being accessible by the container bot 110 from the common rails 1200S. As may be realized, the horizontal support members 1200 also form shelf rails (in addition to shelf rails 1210) on which case units are placed.

Each stacked shelf level 130LS1-130LS3 (and/or each single shelf level as described below) of a corresponding storage level 130L defines an open and undeterministic two dimensional storage surface (e.g., having a case unit/breakpack container support plane CUSP as shown in FIG. 3) that facilitates a dynamic allocation of pickfaces (e.g., supply containers 265) and/or breakpack goods tote(s) 1510A-n both longitudinally (e.g., along a length of the aisle or coincident with a path of bot travel defined by the picking aisle) and laterally (e.g., with respect to rack depth, transverse to the aisle or the path of bot travel). Dynamic allocation of the pickfaces and case units that make up the pickfaces is provided, for example, in the manner described in U.S. Pat. No. 8,594,835 issued on Nov. 26, 2013, the disclosure of which is incorporated by reference herein in its entirety. While supply containers 265 are illustrated in FIG. 2 as being stored on side PAS2 of picking aisle 130A and breakpack goods tote(s) 1510A-n are shown stored on side PAS1 of picking aisle 130A, in other aspects, there may be a mix of supply containers 265 and breakpack goods tote(s) 1510A-n stored on a common side PAS1, PAS2 (e.g., either one or both of sides PAS1, PAS2) of the picking aisle 130A and/or a mix of supply containers 265 and breakpack goods tote(s) 1510A-n stored on a common shelf surface.

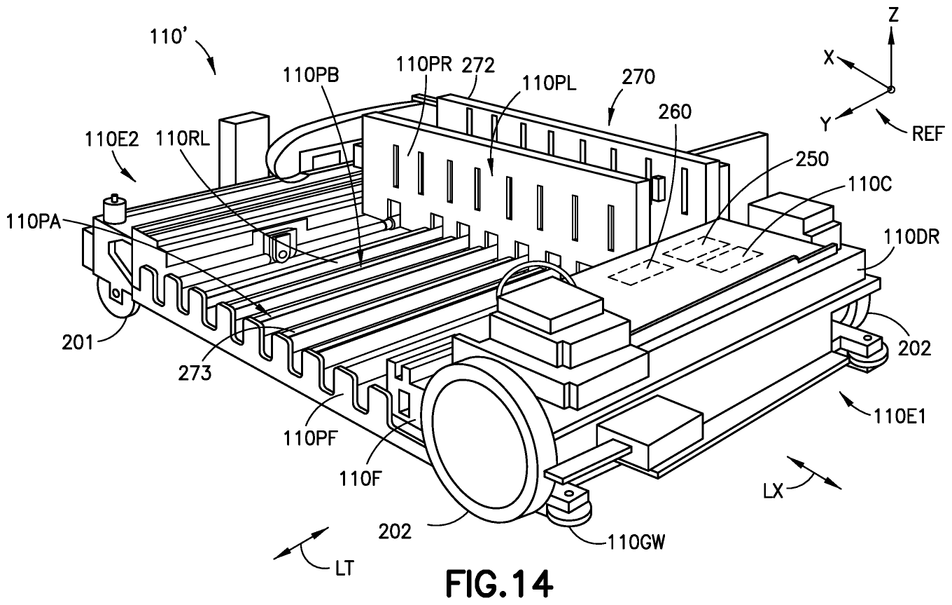

In one aspect, referring to FIGS. 4 and 14 each of the storage levels 130L includes a single level of storage shelves to store a single level of case units (e.g., each storage level includes a single case unit support plane CUSP) and the container bots 110 are configured to transfer case units to and from the storage shelves of the respective storage level 130L. For example, the container bot 110′ illustrated in FIG. 14 is substantially similar to container bot 110 described herein however, the container bot 110′ is not provided with sufficient Z-travel of the transfer arm 110PA for placing case units on the multiple storage shelf levels 130LS1-130LS3 (e.g., accessible from a common rail 1200S) as described above. Here the transfer arm drive 250 (which may be substantially similar to one or more of drive 250A, 250B) includes only sufficient Z-travel for lifting the case units from the case unit support plane CUSP of the single level of storage shelves, for transferring the case units to and from the payload area 110PL and for transferring the case units between the fingers 273 of the transfer arm 110PA and the payload bed 110PB. Suitable examples of container bots 110′ can be found in, for example, U.S. Pat. No. 9,499,338 issued on Nov. 22, 2016, the disclosure of which is incorporated herein by reference in its entirety.

Referring again to FIG. 8 each container transfer deck 130DC or storage level 130L includes one or more lift pickface interface/handoff stations TS (referred to herein as interface stations TS) where case unit(s) (e.g., individual case units, pickfaces, supply containers, etc.), breakpack goods tote(s) 1510A-n are transferred between the lift load handling devices LHD and container bots 110 on the container transfer deck 130DC. The interface stations TS are located at a side of the container transfer deck 130DC opposite the picking aisles 130A and rack modules RM, so that the container transfer deck 130DC is interposed between the picking aisles and each interface station TS. As noted above, each container bot 110 on each picking level 130L has access (via a respective container transfer deck 130DC) to each storage location 130S, each picking aisle 130A and each lift 150 on the respective storage level 130L, as such each container bot 110 also has access to each interface station TS on the respective level 130L. In one aspect the interface stations are offset from high-speed bot travel paths HSTP along the container transfer deck 130DC so that container bot 110 access to the interface stations TS is undeterministic to bot speed on the high-speed travel paths HSTP. As such, each container bot 110 can move a case unit(s) (e.g., individual case units, pickfaces (built by the bot), supply containers, etc.), breakpack goods tote(s) 1510A-n from every interface station TS to every storage space 130S corresponding to the deck level 130L and vice versa.

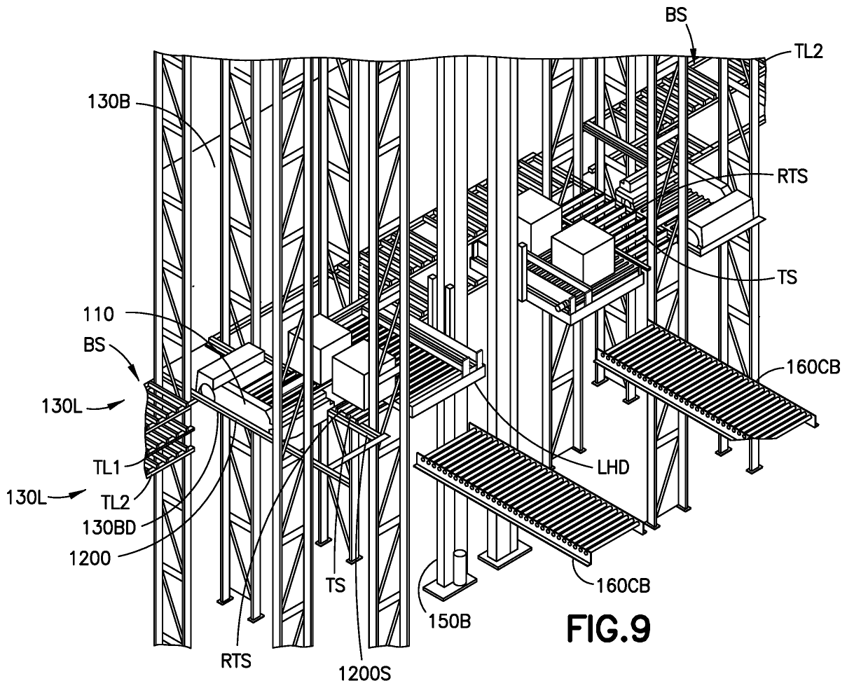

In one aspect the interface stations TS are configured for a passive transfer (e.g., handoff) of case units (e.g., individual case units, pickfaces, supply containers, etc.), breakpack goods tote(s) 1510A-n between the container bot 110 and the load handing devices LHD of the lifts 150 (e.g., the interface stations TS have no moving parts for transporting the case units) which will be described in greater detail below. For example, also referring to FIG. 9 the interface stations TS and/or buffer stations BS include one or more stacked levels TL1, TL2 of transfer rack shelves RTS (e.g., so as to take advantage of the lifting ability of the container bot 110 with respect to the stacked rack shelves RTS) which in one aspect are substantially similar to the storage shelves described above (e.g., each being formed by rails 1210, 1200 and slats 1210S) such that container bot 110 handoff (e.g., pick and place) occurs in a passive manner substantially similar to that between the container bot 110 and the storage spaces 130S (as described herein) where the case units or totes are transferred to and from the shelves. In one aspect, the buffer stations BS on one or more of the stacked levels TL1, TL2 also serve as a handoff/interface station with respect to the load-handling device LHD of the lift 150. In one aspect, where the bots, such as container bots 110′, are configured for the transfer of case units (e.g., individual case units, pickfaces, supply containers, etc.), breakpack goods tote(s) 1510A-n to a single level 130L of storage shelves, the interface stations TS and/or buffer stations BS also include a single level of transfer rack shelves (which are substantially similar to the storage rack shelves of the storage levels 130L described above with respect to, for example, FIG. 3). As may be realized, operation of the storage and retrieval system with container bots 110′ serving the single level storage and transfer shelves is substantially similar to that described herein. As may also be realized, load handling device LHD (or lift) handoff (e.g., pick and place) of case units (e.g., individual case units, pickfaces, supply containers, etc.), breakpack goods tote(s) 1510A-n to the stacked rack shelves RTS (and/or the single level rack shelves) occurs in a passive manner substantially similar to that between the container bot 110 and the storage spaces 130S (as described herein) where the case units, breakpack goods tote(s) 1510A-n are transferred to and from the shelves. In other aspects, the shelves may include transfer arms for picking and placing case units, breakpack goods tote(s) 1510A-n from one or more of the container bot 110 and load-handling device LHD of the lift 150. Suitable examples of an interface station with an active transfer arm are described in, for example, U.S. Pat. No. 9,694,975 issued on Jul. 4, 2017, the disclosure of which is incorporated by reference herein in its entirety.

In one aspect, the location of the container bot 110 relative to the interface stations TS occurs in a manner substantially similar to bot location relative to the storage spaces 130S. For example, in one aspect, location of the container bot 110 relative to the storage spaces 130S and the interface stations TS occurs in a manner substantially similar to that described in U.S. Pat. No. 9,008,884 issued on Apr. 14, 2015 and U.S. Pat. No. 8,954,188 issued on Feb. 10, 2015, the disclosures of which are incorporated herein by reference in their entireties. For example, referring to FIGS. 1 and 3, the container bot 110 includes one or more sensors 110S that detect the slats 1210S or a locating feature 130F (such as an aperture, reflective surface, RFID tag, etc.) disposed on/in the rail 1200. The slats and/or locating features 130F are arranged so as to identify a location of the container bot 110 within the storage and retrieval system, relative to e.g., the storages spaces and/or interface stations TS. In one aspect the container bot 110 includes a controller 110C that, for example, counts the slats 1210S to at least in part determine a location of the container bot 110 within the storage and retrieval system 100. In other aspects the location features 130F may be arranged so as to form an absolute or incremental encoder which when detected by the container bot 110 provides for a container bot 110 location determination within the storage and retrieval system 100.

As may be realized, referring to FIG. 9, the transfer rack shelves RTS at each interface/handoff station TS define multi-load stations (e.g., having one or more storage case unit holding locations for holding a corresponding number of case units or totes 1510A-n) on a common transfer rack shelf RS. As noted above, each load of the multi-load station is a single case unit/tote 1510A-n or a multi-case pickface (e.g., having multiple case units/totes 1510A-n that are moved as a single unit) that is picked and paced by either the container bot 110 or load handling device LHD. As may also be realized, the bot location described above allows for the container bot 110 to position itself relative to the multi-load stations for picking and placing the case units/totes 1510A-n and pickfaces from a predetermined one of the holding locations of the multi-load station. The interface/handoff stations TS define multi-place buffers (e.g., buffers having one or more case holding location) where inbound and/or outbound case units/totes 1510A-n/breakpack goods containers and pickfaces are temporarily stored when being transferred between the container bots 110 and the load handling devices LHD of the lifts 150.

In one aspect one or more peripheral buffer/handoff stations BS (substantially similar to the interface stations TS and referred to herein as buffer stations BS) are also located at the side of the container transfer deck 130DC opposite the picking aisles 130A and rack modules RM, so that the container transfer deck 130DC is interposed between the picking aisles and each buffer station BS. The peripheral buffer stations BS are interspersed between or, in one aspect as shown in FIGS. 8 and 9, otherwise in line with the interface stations TS. In one aspect the peripheral buffer stations BS are formed by rails 1210, 1200 and slats 1210S and are a continuation of (but a separate section of) the interface stations TS (e.g., the interface stations and the peripheral buffer stations are formed by common rails 1210, 1200). As such, the peripheral buffer stations BS, in one aspect, also include one or more stacked levels TL1, TL2 of transfer rack shelves RTS as described above with respect to the interface stations TS while in other aspects the buffer stations include a single level of transfer rack shelves. The peripheral buffer stations BS define buffers where case units/totes 1510A-n and/or pickfaces are temporarily stored when being transferred from one container bot 110 to another different container bot 110 on the same storage level 130L as will be described in greater detail below. As maybe realized, in one aspect the peripheral buffer stations are located at any suitable location of the storage and retrieval system including within the picking aisles 130A and anywhere along the container transfer deck 130DC.

Still referring to FIGS. 8 and 9 in one aspect at least the interface stations TS are located on an extension portion or pier 130BD that extends from the container transfer deck 130DC, although in other aspects a length of the interface stations TS may be arranged and extend along the container transfer deck. In one aspect, the pier 130BD is similar to the picking aisles where the container bot 110 travels along rails 1200S affixed to horizontal support members 1200 (in a manner substantially similar to that described above). In other aspects, the travel surface of the pier 130BD may be substantially similar to that of the container transfer deck 130DC. Each pier 130BD is located at the side of the container transfer deck 130DC, such as a side that is opposite the picking aisles 130A and rack modules RM, so that the container transfer deck 130DC is interposed between the picking aisles and each pier 130BD. The pier(s) 130BD extends from the transfer deck at a non-zero angle relative to at least a portion of the high-speed bot transport path HSTP. In other aspects the pier(s) 130BD extend from any suitable portion of the container transfer deck 130DC including the ends 130BE1, 130BE2 of the container transfer deck 130DCD. As may be realized, peripheral buffer stations BSD (substantially similar to peripheral buffers stations BS described above) may also be located at least along a portion of the pier 130BD.

Referring to FIG. 13, the container bots 110, as noted above, transport case units between each lift module 150 and each storage space 130S on a respective storage level 130L. The container bots 110 include a frame 110F having a drive section 110DR and a payload section 110PL. The drive section 110DR includes one or more drive wheel motors each connected to a respective drive wheel(s) 202 for propelling the container bot 110 along a traverse path on the container deck 130DC and/or picking aisles 130A. In this aspect the container bot 110 includes two drive wheels 202 located on opposite sides of the container bot 110 at end 110E1 (e.g., first longitudinal end) of the container bot 110 for supporting the container bot 110 on a suitable drive surface however, in other aspects any suitable number of drive wheels are provided on the container bot 110. In one aspect, each drive wheel 202 is independently controlled so that the container bot 110 may be steered through a differential rotation of the drive wheels 202 while in other aspects the rotation of the drive wheels 202 may be coupled so as to rotate at substantially the same speed. Any suitable wheels 201 are mounted to the frame on opposite sides of the container bot 110 at end 110E2 (e.g., second longitudinal end) of the container bot 110 for supporting the container bot 110 on the drive surface. In one aspect, the wheels 201 are caster wheels that freely rotate allowing the container bot 110 to pivot through differential rotation of the drive wheels 202 for changing a travel direction of the container bot 110. In other aspects, the wheels 201 are steerable wheels that turn under control of, for example, a bot controller 110C (which is configured to effect control of the container bot 110 as described herein) for changing a travel direction of the container bot 110. In one aspect, the container bot 110 includes one or more guide wheels 110GW located at, for example, one or more corners of the frame 110F. The guide wheels 110GW may interface with the storage structure 130, such as guide rails (not shown) within the picking aisles 130A, on the container transfer deck 130DC and/or at interface or transfer stations for interfacing with the lift modules 150 for guiding the container bot 110 and/or positioning the container bot 110 a predetermined distance from a location to/from which one or more case units are placed and/or picked up as described in, for example, U.S. Pat. No. 9,561,905 issued on Feb. 7, 2017 the disclosure of which is incorporated herein by reference in its entirety.

As noted above, the container bots 110 may enter the picking aisles 130A having different facing directions for accessing storage spaces 130S located on both sides of the picking aisles 130A. For example, the container bot 110 may enter a picking aisle 130A with end 110E2 leading the direction of travel or the bot may enter the picking aisle 130A with end 110E1 leading the direction of travel.

The payload section 110PL of the container bot 110 includes a payload bed 110PB, a fence or datum member 110PF, a transfer arm 110PA and a pusher bar or member 110PR. In one aspect the payload bed 110PB includes one or more rollers 110RL that are transversely mounted (e.g., relative to a longitudinal axis LX of the container bot 110) to the frame 110F so that one or more case units and/or breakpack goods containers carried within the payload section 110PL can be longitudinally moved (e.g., justified with respect to a predetermined location of the frame/payload section and/or a datum reference of one or more case units) along the longitudinal axis of the bot, e.g., to position the case unit and/or breakpack goods containers at a predetermined position within the payload section 110PL and/or relative to other case units and/or breakpack goods containers within the payload section 110PL (e.g., longitudinal forward/aft justification of case units). In other aspects the container bot 110 includes one or more longitudinally movable pusher bar (substantially similar to that described in, for example, U.S. Pat. No. 11,078,017 issued on Aug. 3, 2021, the disclosure of which was previously incorporated by reference herein in its entirety) for pushing the case units and/or breakpack goods containers over the rollers 110RL for moving the case unit(s) and/or breakpack container(s) to the predetermined position within the payload section 110PL.

Still referring to FIG. 13, the case units and/or breakpack goods containers are placed on the payload bed 110PB and removed from the payload bed 110PB with the transfer arm 110PA. The transfer arm 110PA includes a lift mechanism or unit 200 located substantially within the payload section 110PL as described in, for example, U.S. Pat. No. 9,850,079 issued on Dec. 26, 2017, previously incorporated herein by reference in its entirety. The lift mechanism 200 provides both gross and fine positioning of pickfaces (which may include either case units or breakpack goods containers, or both case units and breakpack goods containers) carried by the container bot 110 which are to be lifted vertically into position in the storage structure 130 for picking and/or placing the pickfaces and/or individual case units to the storage spaces 130S (e.g., on a respective storage level 130L on which the container bot 110 is located). For example, the lift mechanism 200 provides for picking and placing case units at the multiple elevated storage shelf levels 130LS1-130LS3, TL1, TL2 accessible from the common picking aisle or interface station deck 1200S (see e.g., FIGS. 2, 9 and 11).

Still referring to FIG. 13 the pick head 270 of the container bot 110 transfers case units between the container bot 110 and a case unit and/or breakpack goods container pick/place location such as, for example, the storage spaces 130S, peripheral buffer stations BS, BSD, interface stations TS (see FIGS. 8-9), breakpack operation station 140 (see FIGS. 1 and 10), tote destacking system(s) 1000, and/or breakpack goods interface 263 (see FIGS. 1 and 10) and in other aspects, substantially directly between the container bot 110 and a lift module(s) 150. In one aspect, the pick head 270 includes a base member 272, one or more tines or fingers 273A-273E and one or more actuators 274A, 274B. The base member 272 is mounted to the mast 200M, as described above, so as to ride along the guide rails 280A, 280B. The one or more tines 273A-273E are mounted to the base member 272 at a proximate end of the tines 273A-273E so that a distal end of the tines 273A-273E (e.g., a free end) is cantilevered from the base member 272. Referring again to FIG. 3, the tines 273A-273E are configured for insertion between slats 1210S that form the case unit support plane CUSP of the storage shelves (and similar slats of the peripheral buffer stations BS, BSD, interface stations TS, breakpack operation station 140, and/or breakpack goods interface 263).

Referring again to FIG. 13, it is again noted that the pusher bar 110PR is movable independent of the transfer arm 110PA. The pusher bar 110PR is movably mounted to the frame in any suitable manner such as by, for example, a guide rod and slide arrangement and is actuated along the Y direction (e.g., in a lateral direction substantially parallel to the extension/retraction direction of the transfer arm 110PA). In one aspect, at least one guide rod 360 is mounted within the payload section 110PL so as to extend transversely relative to the longitudinal axis LX of the frame 110F. The pusher bar 110PR may include at least one slide member 360S configured to engage and slide along a respective guide rod 360. In one aspect, at least the guide rod/slide arrangement holds the pusher bar 110PR captive within the payload section 110PL. The pusher bar 110PR is actuated by any suitable motor and transmission, such as by motor 303 and transmission 303T. In one aspect, the motor 303 is a rotary motor and the transmission 303T is a belt and pulley transmission. In other aspects, the pusher bar 110PR may be actuated by a linear actuator having substantially no rotary components. The pusher bar 110PR may effect justification of case units CY in the payload bed 110PB along a lateral axis of the container bot and may effect gripping of case units CU within the payload bed 110PB (e.g., gripped between the pusher bar 110PB and fence 110PF).

Referring now to FIGS. 1, 7, 8, 10, 12, and 16A-B, and as noted above, the at least one tote destacking system(s) 1000 may be coupled to the structure of the automated storage and retrieval system 100 at any suitable location and at any suitable level(s) 130L. For example, a tote destacking system 1000 may be located at one or more ends 130BE1, 130BE2 of the container transfer deck 130DC or at one or more sides 130BD1, 130BD2 of the container transfer deck 130DC (such as in lieu of storage rack modules RM/picking aisles 130A or lifts 150A, 150B, or as an extension of one or more picking aisles 130A) of at a side of bot lanes adjacent the put wall 263W. Each of the tote destacking system(s) 1000 is a plug and play module that is integrated with (or otherwise connected to) the container transfer deck 130DC so that the container transfer deck 130DC is communicably coupled to at least one output interface station 1001 of the tote destacking system(s) 1000, so that container bots 110 transfer breakpack tote(s) 1510A-n to the at least one breakpack station 266 from the at least one tote destacking system(s) 1000 via the container transport deck 130DC. In other aspects, the output interface station 1001 interfaces with container bots 110 travelling along, and is/are communicably coupled to, picking aisles (see FIG. 8) that extend from the container transport deck 130DC, so that container bots 110 transfer breakpack tote(s) 1510A-n to the at least one breakpack station 266 from the at least one tote destacking system(s) 1000 via the picking aisles 130A. It is noted that where the output interface station 1001 interfaces with picking aisles 130A, the picking aisles 130A may include an undeterministic turn around area (that is similar to the open undeterministic container transfer deck 130DC) on which the container bots 110 turn to pick breakpack tote(s) 1510A-n from the output interface station 1001. Where the output interface station 1001 interfaces with the container transfer deck 130DC, the container transfer deck includes a transfer lane in which the container bots 110 can “parallel park” adjacent a predetermined output interface station 1001 for transfer of breakpack tote(s) 1510A-n between the container bot 110 and the output interface station 1001.

As will be described herein each tote destacking system(s) 1000 includes a tote transport CTP for transporting the tote(s) 1510A-n from robot 999 to the output interface station 1001. The tote transport CTP is configured to transport breakpack goods tote(s) 1510A-n within a respective tote destacking system(s) 1000. The tote transport CTP includes a tote infeed 1010, formed at least in part by the robot 999 and stacks 1505A-n of tote(s) 1510A-n, that is configured to load the tote(s) 1510A-n onto the tote transport path. The tote transport CTP also includes output interface station 1001 that is configured to communicate with the asynchronous container transport (such as container bot 110) so as to unload the tote(s) 1510A-n for transport to the breakpack module 266. The tote transport CTP is any suitable conveyance configured to transport breakpack goods tote(s) 1510A-n between the robot 999 and one or more of the output interface station 1001 and a reject/manual load station 1007. The tote transport CTP may be a roller conveyor, a belt conveyor, a ball conveyor, and/or any other suitable conveyor type or combination of conveyor types that effects transport of the breakpack goods tote(s) 1510A-n within a respective tote destacking system(s) 1000. The robot 999 and the output interface station 1001 are communicably connected by the tote transport CTP.

The tote transport CTP may include at least one barcode scanner 1005 and a transport controller 1006 controllably selecting a container transport path so as to direct the tote(s) 1510A-n to at least one of the output interface station 1001 and a reject/manual load station 1007. The transport controller 1006 is communicably coupled with the at least one barcode scanner 1005 configured so as to scan and track the tote(s) 1510A. The transport controller 1006 is arranged to controllably select the tote transport path to direct the tote(s) 1510A-n to at least one of the output interface station 1001 and the reject/manual load station 1007 based on the scan (a tote without a barcode or a damaged barcode may be rejected). The transport controller 1006 may comprises another barcode scanner 1005A configured so as to scan and track a tote(s) 1510A-n that is manually placed on the tote transport CTP at the reject/manual load station 1007 by an operator. The transport controller 1006 may also include an additional barcode scanner downstream or upstream from the reject/manual load station 1007 in order to scan and track the tote(s) 1510A-n.

Each of the tote destacking system(s) 1000 includes at least the output interface station 1001, the tote transport CTP, the robot 999, and stacks 1505A-n of tote(s) 1510A-n. The output interface station 1001 may be passive interfaces that are substantially similar in structure to what is illustrated in FIGS. 3, and 9 with respect to the storage shelves of the rack modules RM and the buffer and transfer stations BS, TS so that the container bot 110 transfers the breakpack tote(s) 1510A-n between the output interface station 1001 and the transfer arm 110PA in a manner substantially similar to that described herein. The output interface station 1001 includes any suitable container drive device (e.g., pusher, driven spaced apart rollers (spaced apart in a manner similar to the slats 1210S where the fingers of the transfer arm 110PA are inserted in the space between the rollers), etc.) configured to move the breakpack container from the respective output interface station 1001 to the container bot 110. In other aspects, the output interface station 1001 may be a passive interface such that a human operator initiates the transfer to the breakpack module 266.

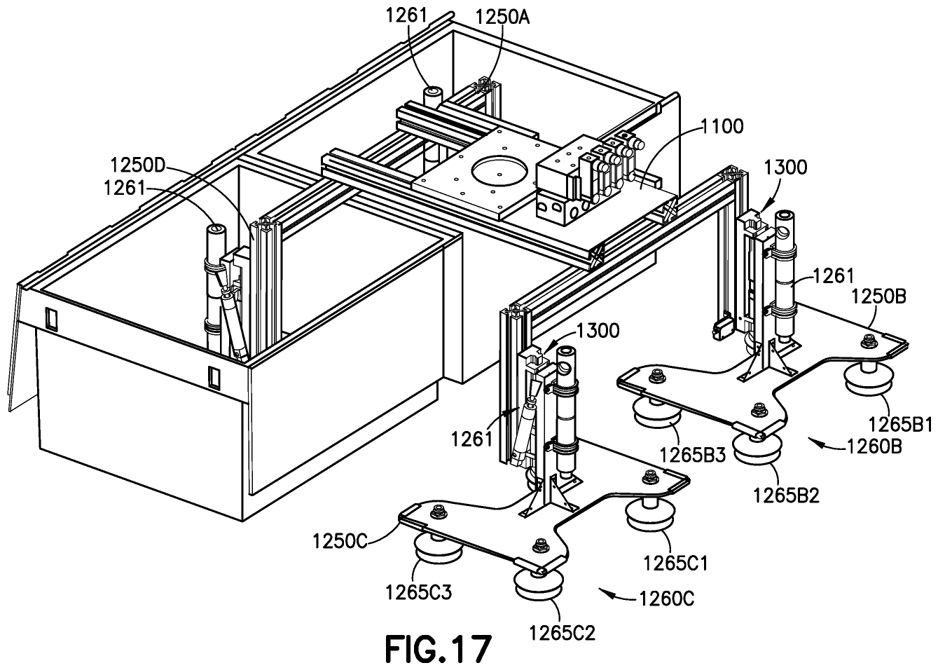

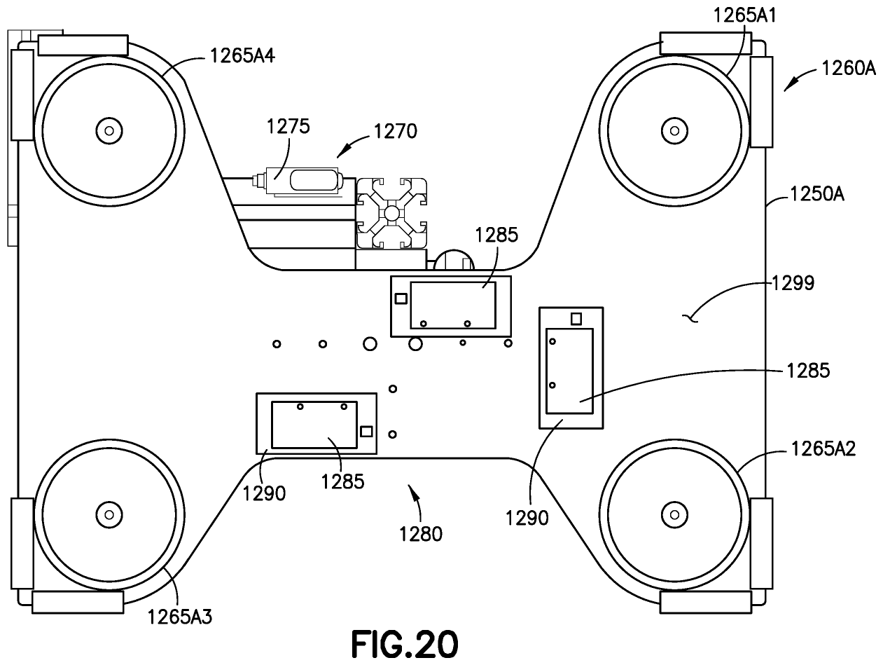

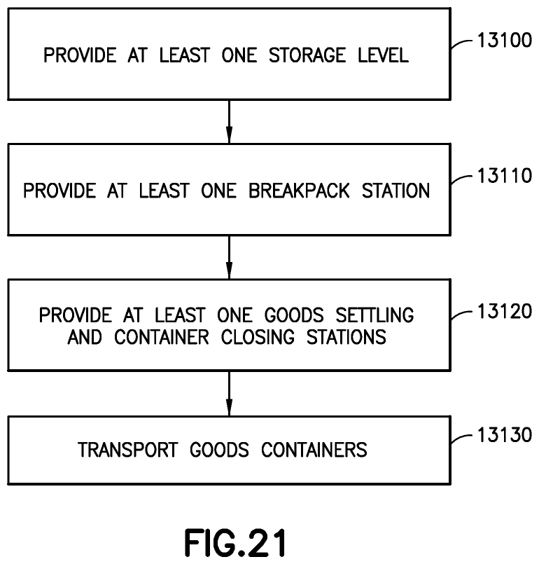

The tote destacking system 1000 for destacking (denesting) tote(s) 1510A-n from stack(s) 1505A-n will now be described with reference to FIGS. 16A-20. As noted previously, the robot 999 is adapted for and equipped with an end of arm tool (end effector) in the form of an automatic product tote destacker tool 1050, which is adapted to pick/denest and transfer tote(s) 1510A-n from a stack 1505A-n to the tote transport CTP for transport to the breakpack modules 266. In the description, the expressions ‘robot’ and ‘robot arm’ are used interchangeably to means a programmable system including a standard 4 or 6 axis industrial articulated arm that receives, controls, and moves an end of arm tool. For example, the robot 999 may be a Comau NJ 165-3.4 SH robot, or any similar robot arm. Additionally, while the robot is described and illustrated as a stationary articulated robot arm, the robot may be any suitable robot system such as a gantry type system or any other system. In another aspect, the robot arm and tool 1050 may be integrated as a single device, providing the combined features of the robot 999 and automatic product tote destacker tool 1050. The robot 999 may include other well-known systems and components that allow its operation, including, e.g., a robot controller 900. Since these systems and components are well known in the art, they will not be described herein in more detail for conciseness.

In the tote destacking system 1000, the robot 999 is generally positioned substantially adjacent a tote unloading station 1600 including one or more tote array 1500 having one or more stack 1505A-n of tote(s) 1510A-n positioned to be picked/destacked by the robot 999 (although the tote array 1500 is illustrated as having four stacks, the tote array 1500 may have any suitable number of stacks which may or may not coincide with a pick head array 1200 of the automatic product tote destacker tool 1050 (i.e., the tote array 1500 may have more or less stacks then the pick head array 1200)). The tote array 1500 can be placed in the tote unloading station 1600 by, e.g., a lift truck, an input tote conveyor, or any other suitable means (not shown) to transport an array having stack(s) 1505A-n of tote(s) 1510A-n.

As noted, the automatic product tote destacker tool 1050 includes the pick head array 1200 of tote pick heads 1250 movably connected to and dependent from a frame 1100. The pick head array 1200 is configured (i.e., includes components) to destack/denest the tote(s) 1510A-n with each respective tote pick head 1250A-n destacking tote(s) 1510A-n) one by one from a respective stack 1505A-n of tote(s) 1510A-n of the tote stack array 1500 (i.e., from uppermost tote array to bottommost tote array of totes 1510A-n of the stack 1505A-n of the tote stack array 1500). For example, the pick head array 1200 is configured to simultaneously hold a single layer of a tote array 1500 to the robot 999. A different respective tote 1510A-n, of the tote array 1500 is held by a corresponding pick head 1250A-n different from each other pick head 1250A-n holding each other different respective tote 1510A-n of the tote array 1500. As will become more apparent based on the following description, the system 1000 is not limited to destacking “totes”, and as noted previously, the expression “tote” is used herein for convenience but includes any type of stacked totes, containers, boxes, buckets, cartons, crates, etc. Moreover, even though the system 1000 is described as picking from stacks 1505A-n of tote(s) 1510A-n that are tightly stacked one above the other, it may be utilized to pick an array of tote(s) 1510A-n that are not stacked such as the bottommost layer.

Referring still to at least FIGS. 16-20, the pick head array 1200 includes the tote pick heads 1250A-n movably connected to and dependent from the frame 1100. For example, a drive section 1300 may be connected (so as to be dependent) to the frame 1100 and operably coupled to each pick head 1250A-n in order to drive the pick heads 1250A-n relative to the frame 1100. The pick heads 1250A-n are moved by the drive section 1300, as a unit or individually, in at least one direction LS relative to the robot 999 and in compliance with a level of the corresponding tote 1510A-n as will be further described below. In one aspect, the drive section 1300 may be a linear slide 1900 or prismatic joint having at least a drive motor 1901 and guide rail 1902. The drive motor 1901 and guide rail 1902 are generally coupled to the frame 1100 in any suitable manner (such as with fasteners). The pick heads 1250A-n may be directly coupled to the each of the drive motor 1901 and the guide rail 1902 or may be coupled to a carriage so that the drive motor 1901 drives the pick heads 1250A-n linearly along the guide rail 1902 in the at least one direction LS. In other aspects, the drive section 1300 may be any other suitable drive to move the pick heads 1250A-n in the at least one direction LS relative to the robot 999. Additionally, the drive section 1300 may include another drive to move the pick heads 1250A-n in a direction different than the at least one direction LS relative to the robot 999 such as to pivot or rotate the pick heads 1250A-n.

Each pick head 1250A-n has a respective tote grip 1260A-n that engages and grips a corresponding tote 1510A-n. In the illustrated examples, the automatic product tote destacker tool 1050 is shown having four pick heads 1250A-D, each having a respective tote grip 1260A-D, however, it is noted that the automatic product tote destacker tool 1050 may include any number of pick heads 1250A-n each having any number of tote grips 1260A-n. Additionally, automatic product tote destacker tool 1050 functions whether the tote array 1500 includes one stack, four stacks, or any number of stacks whether or not the number coincides with the pick head array 1200 of the automatic product tote destacker tool 1050 (i.e., the tote array 1500 may have more or less stacks then the pick head array 1200 and the pick head array 1200 still picks the uppermost tote of the stacks that the pick head array accesses). In one aspect, the tote grip 1260A-n is an active grip disposed to capture and grip the corresponding tote 1510A-n to the corresponding pick head 1250A-n. The tote grips 1260A-n are generally illustrated as a vacuum gripper, however, the grip may be effected by any suitable means such as pneumatic grippers, hydraulic grippers, adaptive grippers, etc., or some combination of the various type of grippers. In the aspect where the tote grip 1260A-n is a vacuum gripper, the tote grip 1260A-n may be a distributed grip (i.e., having multiple grip contacts 1265A1-nm distributed about the pick heads 1250A-n to provide a distributed grip). The multiple grip contacts 1265A1-nm are configured for engagement with the corresponding tote 1510A-n gripped by the pick head 1250A-n. For example, the grip contacts 1265A1-nm are resiliently compliant suction cups with bellows to adapt to uneven or tilted tote(s) 1510A-n. It is noted that in the illustrated examples, the pick heads 1250A-D, are illustrated as having a tote grip 1260A-D each with four grip contacts 1265A1-D4, however, it is noted that the automatic product tote destacker tool 1050 may include any number of tote grips each having any number of grip contacts (including less than four, such as three, two, or one contact).

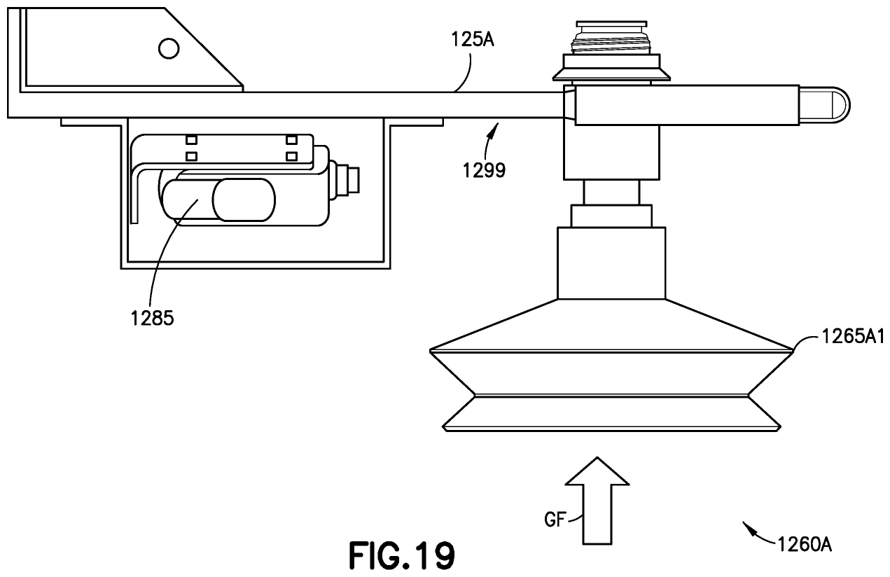

The tote grip 1260A-n active generates, on actuation, an upward grip force GF (FIG. 19) on the tote 1510A-n with the grip contact 1265A1-nm seated against the interior bottom surface 264BS (FIG. 15) of the gripped tote 1510A-n so as to effect the tote pick, lifting the corresponding tote 1510A-n free from the stack 1505A-n. In one aspect, the multiple grip contacts 1265A1-nm of the pick head 1250A-n lift corresponding totes 1510A-n free from the stack 1505A-n with at least one of the multiple grip contacts 1265A1-nm of the pick head 1250A-n inoperative (i.e., each pick head 1250A-n grips and picks a tote independent of others such that if one pick head 1250A-n is inoperative or operative without a corresponding tote stack in the tote stack array, or in the event the pick head fails due to tote stacking interference that defeats capture by the one pick head, the other pick heads 1250A-n still pick their respective tote). As noted, each grip contact 1265A1-nm of the tote grip 1260A-n is resiliently compliant and disposed to seat on the interior bottom surface 264BS (FIG. 15) of the tote 1510A-n, wherein the pick head 1250A-n accesses the tote 1510A-n through an opening 264OP of the tote 1510A-n.

In one aspect, the tote grip 1260A-n is a vacuum grip generated by a venturi 1261 providing a robust and metered suction (vacuum) to grip the corresponding tote 1510A-n. The venturi suction is resistant to loss of suction due to blockage such as debris and detritus present in the tote. Where the active grip is metered, the tote 1510A-n and tote grip 1260A-n are configured to decouple automatically upon the pick head 1250A-n initiating a tote pick of more than one tote 1510A-n (i.e., in the event two totes (due to nesting adhesion) are picked in one pick the tote grip will decouple automatically from the tote and may indicate as a failed pick). Automatic decoupling occurs as the weight of two totes exceeds the pick head pick suction (e.g., via venture vacuum). The pick head 1250A-n is metered (has a tote pick meter configured) so that, for each tote pick from a stack 1505A-n of totes 1510A-n, the pick head 1250A-n automatically and repeatedly picks but the corresponding tote 1510A-n (singly or alone) from the stack 1505A-n, substantially throughout each destacking pick by the automatic product tote destacker tool 1050 destacking the stack 1505A-n of totes 1510A-n from uppermost to bottom most totes 1510A-n of the stack 1505A-n. In one aspect, each separate pick head 1250A-n is metered (has a tote pick meter configured) so that each separate pick head 1250A-n respectively (individually) effects a tote pick from stacked totes 1510A-n separately gripping but the corresponding tote from the respective pick head 1250A-n for each tote pick effected substantially simultaneously by the pick head array 1200 and substantially simultaneously destacking stacks 1505A-n of totes 1510A-n with the automatic product tote destacker tool 1050. The pick head meter configuration effects automatic tote decoupling from the tote grip 1260A-n of the pick head 1250A-n upon the pick head 1250A-n initiating a tote pick of more than one tote 1510A-n, from the stack 1505A-n of totes 1510A-n, so that each pick head 1250A-n that effects the tote pick grips but the corresponding tote 1510A-n destacking the stack 1505A-n.

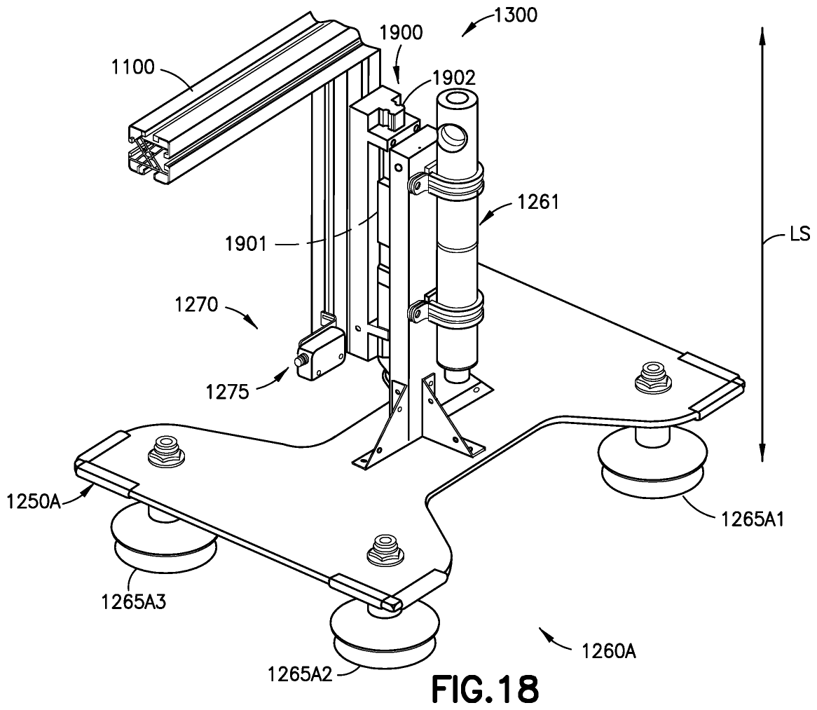

Referring to FIGS. 18-20, the automatic product tote destacker tool 1050 further includes a first sensor system 1270 having one or more sensors 1275 that are disposed relative to the pick head array 1200 so as to be positioned over the tote array 1500 during pick of the totes(s) 1510A-n. The one or more sensors 1275 are generally arranged to determine a bottom 264BS of the corresponding tote 1510A-n in the stack 1505A-n. For example, the sensor system 1270 may include any suitable vertical distance sensor disposed so that the tote array 1500 is within a field of view (in the case of, e.g., an imaging sensor) or an electromagnetic beam (in the case of, e.g., a reflective beam sensor) of the sensor 1275. The first sensor system 1270 is not limited to being fixed to the frame 1100 above the tote unloading station 1600 and may be arranged in any suitable manner to determine vertical distances between the pick head array 1200 and the tote array 1500.

The sensor 1275 is configured to detect a stack 1505A-n of totes 1510A-n and determine one or more of a height of the stack 1505A-n, a distance of the pick head array 1200 from the stack 1505A-n, a distance of the bottom of the uppermost tote 1510A-n from the pick head array, whether one stack 1505A-n includes more totes than another stack 1505A-n, or any other suitable vertical distances to assist in effecting pick of the tote(s) 1510A-n from the stack 1505A-n. For Example, the first sensor system 1270 is disposed to acquire sufficient mapping data to determine the vertical orientation of the tote array 1500, as mapped, e.g., from above. The sensors 1275 may be any suitable sensor such as ultrasonic, IR, LIDAR, reflective, optical, etc. to capture the map data. The expression “map” or “mapped data” in the description includes any type of data that forms a two-dimensional (2D) or three-dimensional (3D) representation of one or more tote including 2D or 3D conventional grey-tone or color images, depth maps, topography images, height data, etc. The maps or depth values obtained from the sensor system can be utilized to assess, validate and/or correct gripping points on a selected layer of tote 1510A-n for a corresponding pick head 1250A-n of the pick head array 1200. The robot 999 is configured to position the sensors 1275 over the tote array 1500 to determine, e.g., a depth of the tote(s) 1510A-n and height of stack 1505A-n. This determination generally occurs before a first tote(s) 1510A-n is gripped and picked, however, may occur at any point between picks until the tote array 1500 is exhausted. This yields a dynamic depth map for the uppermost tote(s) 1510A-n in the tote array 1500, which is utilized by controller 900 to determine, e.g., the coordinates/position/orientation of the uppermost tote(s) 1510A-n.

The sensors 1275 are connected to controller 900 configured for the transfer of captured map data between the sensors 1275 and the controller 900. The controller 900 is configured or programmed for analyzing the map acquired by the first sensor system 1270, analyzing characteristics to determine coordinates of the individual upper tote(s) A-n in the stack(s) 1505A-n. Examples of characteristics analyzed by the controller 900 include depth of the tote(s) 1510A-n, height of the stack(s) 1505A-n, number of stack(s) 1505A-n, etc. The controller 900 may be wired or wirelessly coupled to the robot 999 and configured to send the map thereto for effecting pick of the top layer of tote(s) 1510A-n. The “controller” should be understood as including one or more electronic devices, for example, one or more computers, processors, microcontrollers, etc. that are configured with components and/or programmed with instructions that produce one or more functionalities for effecting pick/denest of the tote(s) 1510A-n.

The controller 900 may be programmed to request a new acquisition by the first sensor system 1270 according to predetermined criteria, such as the arrival of a new tote array in the tote unloading station 1600, a problematic scan, a failed pick, etc. As an example, two side-by-side stacks 1505A-n of tote(s) 1510A-n in a tote array 1500 are mapped by the first sensor system 1270. The controller 900 is configured to evaluate, in such instances, the array 1500 and indicates to the robot 999 to pick the tote(s) 1510A-n. In the event of a failed pick, the controller 900 may be programmed to request a new acquisition by the first sensor system 1270 based on, e.g., an inoperative pick head, which could otherwise lead to difficulty in identifying and picking the next tote(s) 1510A-n.

In one aspect, the pick head 1250A-n includes a second sensor system 1280 having one or more range sensors 1285. The second sensor system 1280 may cooperate with the first sensor system to map the tote(s) 1510A-n ahead of or proximate insertion of the pick heads 1250A-n into the tote(s) 1510A-n through the tote opening 264OP. The map detects and identifies bounds of the tote sides 264S. edges 264E, bottom 264BS, orientation, etc. The second sensor system 1280 includes any suitable range sensors, such as ultrasonic, IR proximity, laser, optical, etc. to determine the positioning and orientation of the tote(s) 1510A-n before being picked and placed on the tote transport CTP (FIG. 7). In one aspect, the second sensor system 1280 is generally disposed on the bottom surface 1299 of a respective pick head 1250A-n (i.e., the surface that faces the tote array 1500) and is oriented so as to map the tote(s) 1510A-n ahead of or proximate insertion into the tote(s) 1510A-n. As noted, the one or more range sensors 1285 are arranged for detection of at least one of sides 264S, edges 264E, and the opening 264OP (FIG. 15) of the corresponding tote 1510A-n in the stack 1505A-n. In some aspects, the sensor system 1280 also confirms that tote(s) 1510A-n are picked by the automatic product tote destacker tool 1050.

The sensor system 1280 may include any suitable range sensor disposed so that the tote array 1500 is within a field of view (in the case of, e.g., an imaging sensor) or an electromagnetic beam (in the case of, e.g., a reflective beam sensor) of the sensor 1285. The second sensor system 1280 is not limited to being fixed to the bottom surface 1299 of a respective pick head 1250A-n and may be arranged in any suitable manner to determine range between the pick head array 1200 and the tote array 1500. In one aspect, the second sensor system 1280 may include a cover (such as a bracket 1290) to protect the sensor in the event of, e.g., a collision with a tote.

For example, each pick head 1250A-n respectively accesses a different stack 1505A-n, substantially simultaneously, so that the pick head array 1200 access the tote array 1500 of stacks 1505A-n, and each different pick head 1250A-n enters, captures and tote picks the tote 1510A-n corresponding to the pick head 1250A-n substantially simultaneously with each other of the different pick heads 1250A-n of the pick head array 1200 picking totes 1510A-n from the respective stacks 1505A-n of the tote array 1500. Generally, the second sensor system 1280 determines orientation and position of each corresponding tote 1510A-n relative to the pick head array 1200 so that the robot 999 effects transfer the corresponding totes 1510A-n onto the tote transport CTP (FIG. 7) in a predetermined manner, yielding a flow of empty tote 1510A-n aligned in a desired orientation on the tote transport CTP.

The second sensor system 1280 is wired to the controller 900 or wirelessly coupled thereto and is configured for the transfer of acquired map data to the controller 900. Once the tote(s) 1510A-n position relative to the pick head array 1200 is determined by the controller 900, the controller 900 identifies to the robot 999 movement displacement instructions that will precisely place the pick head array 1200 at predetermined location and orientation above the tote array 1500.

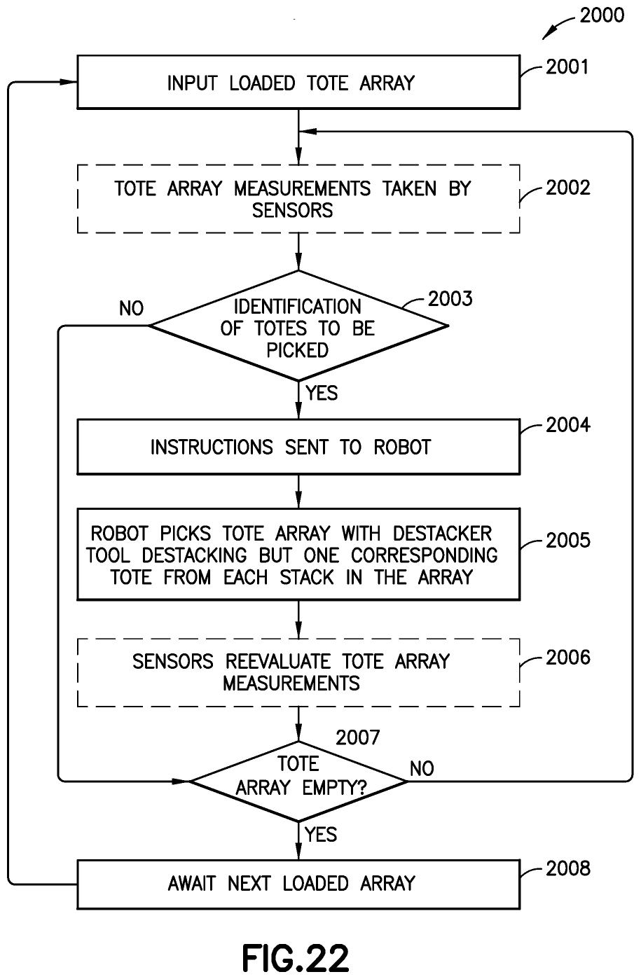

Referring also to FIG. 22, a flow chart for a tote picking method 2000 will now be described in more detail with reference to operation of the system 1000.

In block 2001, array 1500 loaded with stacks 1505A-n of tote(s) 1510A-n is forwarded next to the robot 999 at the tote unloading station 1600. The first sensors 1270 maps the upper tote(s) 1510A-n in the stack 1505A-n and more specifically obtains a depth map of the upper tote(s) 1510A-n (block 2002). Additionally, the second sensors 1280 may take measurements of the tote array 1500 in order to detect edges 264E, sides 264S, and openings 264OP of the corresponding totes 1510A-n. In step 2003, the controller 900 utilizes the depth map to determine the next tote(s) 1510A-n to be pick/denested.

The controller 900 chooses the highest tote(s) 1510A-n or, if all upper tote(s) 1510A-n are at the same depth, than the controller indicates to the robot to pick the upper layer array of tote(s) 1510A-n (block 2003). The uppermost layer is determined using a bottom surface detection method. Alternatively or additionally to such method, for example when depth is inconclusive, a tote(s) 1510A-n edges 264E and sides 264S may be detected.

Instructions are then sent to the robot 999 by the controller 900 (block 2004) which then grips, using the pick head array 1200 of the destacker tool 1050, but one corresponding tote(s) 1510A-n from each corresponding stack 1505A-n of the tote array 1500 (see FIG. 16B), and moves the tote array to the tote infeed 1010 (block 2005) (see FIG. 2).

When a tote(s) 1510A-n cannot be identified in step 2003, the stack 1505A-n is considered empty (block 2007) and the system 1000 waits for the arrival of a new tote array 1500 with stacks 1505A-n of tote(s) 1510A-n (block 2008).

In block 2006, map data is acquired by the second sensor system 1280 and sent to the controller 900, which assists in determining the position and orientation of the tote(s) 1510A-n relative to the pick head array 1200. The controller 900 uses this information in determining the displacement requires by the robot 999 to pick the tote(s) 1510A-n.

Each time an array of tote(s) 1510A-n is moved on the tote transport CTP, the method proceeds with block 2002, wherein the controller 900 determines whether the tote array 1500 is empty, and if so, wait for a new loaded tote array 1500. If not then the method returns to block 2003. The stack 1505A-n is determined to be empty when the highest depth equals the known distance of the bottom of the stack 1505A-n for example.

It is to be noted that many other modifications could be made to the tote picking system 1000 and methods described hereinabove and illustrated in the appended drawings. For example, to increase the production rate, two robot arms can be used for example along with two or more tote transports CTP.

In accordance with one aspect of the disclosed embodiment an automatic product tote destacker tool is provided. The automatic product tote destacker tool including a frame with a coupling configured so as to mate the automatic product tote destacker tool to a robot end so that the automatic product tote destacker tool provides the robot with an end effector; a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head; and a drive section connected to the frame and operably coupled to each tote pick head to move the tote pick head as a unit, relative to the frame, in compliance with a level of the corresponding tote; wherein the tote pick head is metered so that, for each tote pick from a stack of totes, the tote pick head automatically and repeatedly picks but the corresponding tote from the stack, substantially throughout each destacking pick by the automatic product tote destacker tool destacking the stack of totes from uppermost to bottommost totes of the stack.

In accordance with one aspect of the disclosed embodiment the pick head meter configuration effects automatic tote decoupling from the tote grip of the tote pick head upon the tote pick head initiating a tote pick of more than one tote, from the stack of totes, so that each tote pick head that effects the tote pick grips but the corresponding tote destacking the stack.

In accordance with one aspect of the disclosed embodiment the tote grip is an active grip disposed to capture and grip the corresponding tote to the tote pick head, and the active grip is metered so that the tote and grip decouple upon the tote pick head initiating a tote pick of more than one tote.

In accordance with one aspect of the disclosed embodiment the tote grip is distributed so that for each tote pick head, the tote grip forms multiple grip contacts configured for engagement with the corresponding tote gripped by the tote pick head.

In accordance with one aspect of the disclosed embodiment each grip contact of the tote grip is resiliently compliant and disposed to seat on an interior bottom surface of the tote, wherein the tote pick head accesses the tote through an opening of the tote.

In accordance with one aspect of the disclosed embodiment each grip contact is active generating, on actuation, an upward grip force on the tote with the grip contact seated against the interior bottom surface of a gripped tote.

In accordance with one aspect of the disclosed embodiment the tote grip is configured so that the upwards force grips the corresponding tote to the tote pick head so as to effect the tote pick, lifting the corresponding tote free from the stack, with at least one of the multiple grip contacts of the tote pick head inoperative.

In accordance with one aspect of the disclosed embodiment the tote grip is a vacuum grip generated by a venturi providing a metered suction so as to grip the corresponding tote.

In accordance with one aspect of the disclosed embodiment the pick head array has at least one distance sensor arranged to determine a bottom of the corresponding tote in the stack.

In accordance with one aspect of the disclosed embodiment the pick head array has at least one distance sensor arranged so as to determine one or more of sides, edges, and opening of the corresponding tote in the stack.

In accordance with one aspect of the disclosed embodiment each tote pick head, of the pick head array, has a corresponding one of the at least one distance sensor disposed so that the position of the pick head array is determined relative to a group of the stacks, wherein each tote pick head respectively accesses a different stack, substantially simultaneously, so that the pick head array access the group of stacks, and each different tote pick head enters, captures and tote picks the tote corresponding to the tote pick head substantially simultaneously with each other of the different tote pick heads of the pick head array tote picking totes from the respective stacks of the group.

In accordance with one aspect of the disclosed embodiment an automatic product tote destacker tool is provided. The automatic product tote destacker tool including a frame with a coupling configured so as to mate the automatic product tote destacker tool to a robot end so that the automatic product tote destacker tool provides the robot with an end effector; and a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head; each tote pick head being movably coupled to the frame so that the tote pick head moves, as a unit, relative to the robot compliant with a level of the corresponding tote; wherein the tote pick head is metered so that each separate tote pick head respectively effecting a tote pick from stacked totes separately grips but the corresponding tote from the respective tote pick head for each tote pick effected substantially simultaneously by the pick head array and substantially simultaneously destacking stacks of totes with the automatic product tote destacker tool.

In accordance with one aspect of the disclosed embodiment a drive section dependent from the frame and operably coupled to each tote pick head so actuate the tote pick head in at least one direction relative to the robot.

In accordance with one aspect of the disclosed embodiment the tote pick head is metered so that, for each tote pick from a stack of totes, the tote pick head automatically and repeatedly picks but the corresponding tote from the stack, substantially throughout each destacking pick by the automatic product tote destacker tool destacking the stack of totes from uppermost to bottom most totes of the stack.

In accordance with one aspect of the disclosed embodiment the pick head meter configuration effects automatic tote decoupling from the tote grip of the tote pick head upon the tote pick head initiating a tote pick of more than one tote, from the stack of totes, so that each tote pick head that effects the tote pick grips but the corresponding tote destacking the stack.

In accordance with one aspect of the disclosed embodiment the tote grip is an active grip disposed to capture and grip the corresponding tote to the tote pick head, and the active grip is metered so that the tote and grip decouple upon the tote pick head initiating a tote pick of more than one tote.

In accordance with one aspect of the disclosed embodiment the tote grip is distributed so that for each tote pick head, the tote grip forms multiple grip contacts configured for engagement with the corresponding tote gripped by the tote pick head.

In accordance with one aspect of the disclosed embodiment each grip contact of the tote grip is resiliently compliant and disposed to seat on an interior bottom surface of the tote, wherein the tote pick head accesses the tote through an opening of the tote.

In accordance with one aspect of the disclosed embodiment each grip contact is active generating, on actuation, an upward grip force on the tote with the grip contact seated against the interior bottom surface of a gripped tote.

In accordance with one aspect of the disclosed embodiment the tote grip is configured so that the upwards force grips the corresponding tote to the tote pick head so as to effect the tote pick, lifting the corresponding tote free from the stack, with at least one of the multiple grip contacts of the tote pick head inoperative.

In accordance with one aspect of the disclosed embodiment the tote grip is a vacuum grip generated by a venturi providing a metered suction so as to grip the corresponding tote.

In accordance with one aspect of the disclosed embodiment the pick head array has at least one distance sensor arranged to determine a bottom of the corresponding tote in the stack.

In accordance with one aspect of the disclosed embodiment the pick head array has at least one distance sensor arranged so as to determine one or more of sides, edges, and opening of the corresponding tote in the stack.

In accordance with one aspect of the disclosed embodiment each tote pick head, of the pick head array, has a corresponding one of the at least one distance sensor disposed so that the position of the pick head array is determined relative to a group of the stacks, wherein each tote pick head respectively accesses a different stack, substantially simultaneously, so that the pick head array access the group of stacks, and each different tote pick head enters, captures and tote picks the tote corresponding to the tote pick head substantially simultaneously with each other of the different tote pick heads of the pick head array tote picking totes from the respective stacks of the group.

In accordance with one aspect of the disclosed embodiment a method of destacking totes with an automatic product tote destacker tool is provided. The method including providing a frame of the automatic product tote destacker tool, the frame having a coupling configured for mating the automatic product tote destacker tool to a robot end so that the automatic product tote destacker tool provides the robot with an end effector; providing a pick head array of tote pick heads movably connected to and dependent from the frame, the pick head array being configured for simultaneously holding a tote array to the robot, with a different respective tote, of the tote array, being held by a corresponding tote pick head different from each other tote pick head holding each other different respective tote of the tote array, wherein each tote pick head has a tote grip engaging the tote corresponding to the tote pick head; and providing a drive section connected to the frame and operably coupled to each tote pick head for moving the tote pick head as a unit, relative to the frame, in compliance with a level of the corresponding tote; automatically and repeatedly picking totes from a stack of totes, wherein the tote pick head is metered so that, for each tote pick from the stack of totes, the tote pick head automatically and repeatedly picks but the corresponding tote from the stack, substantially throughout each destacking pick by the automatic product tote destacker tool destacking the stack of totes from uppermost to bottommost totes of the stack.

In accordance with one aspect of the disclosed embodiment further including effecting, with the pick head meter configuration, automatic tote decoupling from the tote grip of the tote pick head upon the tote pick head initiating a tote pick of more than one tote, from the stack of totes, so that each tote pick head that effects the tote pick grips but the corresponding tote destacking the stack.

In accordance with one aspect of the disclosed embodiment the tote grip is an active grip disposed for capturing and gripping the corresponding tote to the tote pick head, and the active grip is metered so that the tote and grip decouple upon the tote pick head initiating a tote pick of more than one tote.

In accordance with one aspect of the disclosed embodiment the tote grip is distributed so that for each tote pick head, the tote grip forms multiple grip contacts configured for engaging with the corresponding tote gripped by the tote pick head.

In accordance with one aspect of the disclosed embodiment each grip contact of the tote grip is resiliently compliant and disposed for seating on an interior bottom surface of the tote, the tote pick head accessing the tote through an opening of the tote.

In accordance with one aspect of the disclosed embodiment each grip contact is active generating, on actuation, an upward grip force on the tote with the grip contact seated against the interior bottom surface of a gripped tote.

In accordance with one aspect of the disclosed embodiment the tote grip is configured so that the upwards force grips the corresponding tote to the tote pick head so as to effect the tote pick, lifting the corresponding tote free from the stack, with at least one of the multiple grip contacts of the tote pick head inoperative.

In accordance with one aspect of the disclosed embodiment the tote grip is a vacuum grip generated by a venturi providing a metered suction so as to grip the corresponding tote.

In accordance with one aspect of the disclosed embodiment the pick head array has at least one distance sensor arranged for determining a bottom of the corresponding tote in the stack.

In accordance with one aspect of the disclosed embodiment the pick head array has at least one distance sensor arranged for determining one or more of sides, edges, and opening of the corresponding tote in the stack.

In accordance with one aspect of the disclosed embodiment each tote pick head, of the pick head array, has a corresponding one of the at least one distance sensor disposed so that the position of the pick head array is determined relative to a group of the stacks, each tote pick head respectively accessing a different stack, substantially simultaneously, so that the pick head array access the group of stacks, and each different tote pick head enters, captures and tote picks the tote corresponding to the tote pick head substantially simultaneously with each other of the different tote pick heads of the pick head array tote picking totes from the respective stacks of the group.

In accordance with one aspect of the disclosed embodiment a method of destacking totes with an automatic product tote destacker tool is provided. The method including providing a frame of the automatic product tote destacker tool, the frame having a coupling configured for mating the automatic product tote destacker tool to a robot end so that the automatic product tote destacker tool provides the robot with an end effector; providing a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head, each tote pick head being movably coupled to the frame so that the tote pick head moves, as a unit, relative to the robot compliant with a level of the corresponding tote; and respectively effecting, with each separate tote pick head being metered, a tote pick from stacked totes, wherein each separate tote pick head is metered to separately grip but the corresponding tote from the respective tote pick head for each tote pick effected substantially simultaneously by the pick head array and substantially simultaneously destacking stacks of totes with the automatic product tote destacker tool.

In accordance with one aspect of the disclosed embodiment further including providing a drive section dependent from the frame and operably coupled to each tote pick head so actuate the tote pick head in at least one direction relative to the robot.

In accordance with one aspect of the disclosed embodiment the tote pick head is metered so that, for each tote pick from a stack of totes, the tote pick head automatically and repeatedly picks but the corresponding tote from the stack, substantially throughout each destacking pick by the automatic product tote destacker tool destacking the stack of totes from uppermost to bottom most totes of the stack.

In accordance with one aspect 41 of the disclosed embodiment further including effecting, with the pick head meter configuration, automatic tote decoupling from the tote grip of the tote pick head upon the tote pick head initiating a tote pick of more than one tote, from the stack of totes, so that each tote pick head that effects the tote pick grips but the corresponding tote destacking the stack.

In accordance with one aspect of the disclosed embodiment the tote grip is an active grip disposed for capturing and gripping the corresponding tote to the tote pick head, and the active grip is metered so that the tote and grip decouple upon the tote pick head initiating a tote pick of more than one tote.

In accordance with one aspect of the disclosed embodiment the tote grip is distributed so that for each tote pick head, the tote grip forms multiple grip contacts configured for engaging with the corresponding tote gripped by the tote pick head.

In accordance with one aspect of the disclosed embodiment each grip contact of the tote grip is resiliently compliant and disposed for seating on an interior bottom surface of the tote, the tote pick head accessing the tote through an opening of the tote.

In accordance with one aspect of the disclosed embodiment each grip contact is active generating, on actuation, an upward grip force on the tote with the grip contact seated against the interior bottom surface of a gripped tote.

In accordance with one aspect of the disclosed embodiment the tote grip is configured so that the upwards force grips the corresponding tote to the tote pick head so as to effect the tote pick, lifting the corresponding tote free from the stack, with at least one of the multiple grip contacts of the tote pick head inoperative.

In accordance with one aspect of the disclosed embodiment the tote grip is a vacuum grip generated by a venturi providing a metered suction so as to grip the corresponding tote.

In accordance with one aspect of the disclosed embodiment the pick head array has at least one distance sensor arranged for determining a bottom of the corresponding tote in the stack.

In accordance with one aspect of the disclosed embodiment the pick head array has at least one distance sensor arranged for determining one or more of sides, edges, and opening of the corresponding tote in the stack.

In accordance with one aspect of the disclosed embodiment each tote pick head, of the pick head array, has a corresponding one of the at least one distance sensor disposed so that the position of the pick head array is determined relative to a group of the stacks, each tote pick head respectively accessing a different stack, substantially simultaneously, so that the pick head array access the group of stacks, and each different tote pick head enters, captures and tote picks the tote corresponding to the tote pick head substantially simultaneously with each other of the different tote pick heads of the pick head array tote picking totes from the respective stacks of the group.

It should be understood that the foregoing description is only illustrative of the aspects of the disclosed embodiment. Various alternatives and modifications can be devised by those skilled in the art without departing from the aspects of the disclosed embodiment. Accordingly, the aspects of the disclosed embodiment are intended to embrace all such alternatives, modifications and variances that fall within the scope of any claims appended hereto. Further, the mere fact that different features are recited in mutually different dependent or independent claims does not indicate that a combination of these features cannot be advantageously used, such a combination remaining within the scope of the aspects of the disclosed embodiment.

1. An automatic product tote destacker tool comprising:
a frame with a coupling configured so as to mate the automatic product tote destacker tool to a robot end so that the automatic product tote destacker tool provides the robot with an end effector;
a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head; and
a drive section connected to the frame and operably coupled to each tote pick head to move the tote pick head as a unit, relative to the frame, in compliance with a level of the corresponding tote;
wherein the tote pick head is metered so that, for each tote pick from a stack of totes, the tote pick head automatically and repeatedly picks but the corresponding tote from the stack, substantially throughout each destacking pick by the automatic product tote destacker tool destacking the stack of totes from uppermost to bottommost totes of the stack.

2. The automatic product tote destacker tool of claim 1, wherein the pick head meter configuration effects automatic tote decoupling from the tote grip of the tote pick head upon the tote pick head initiating a tote pick of more than one tote, from the stack of totes, so that each tote pick head that effects the tote pick grips but the corresponding tote destacking the stack.

3. The automatic product tote destacker tool of claim 1, wherein the tote grip is an active grip disposed to capture and grip the corresponding tote to the tote pick head, and the active grip is metered so that the tote and grip decouple upon the tote pick head initiating a tote pick of more than one tote.

4. The automatic product tote destacker tool of claim 1, wherein the tote grip is distributed so that for each tote pick head, the tote grip forms multiple grip contacts configured for engagement with the corresponding tote gripped by the tote pick head.

5. The automatic product tote destacker tool of claim 4, wherein each grip contact of the tote grip is resiliently compliant and disposed to seat on an interior bottom surface of the tote, wherein the tote pick head accesses the tote through an opening of the tote.

6. The automatic product tote destacker tool of claim 5, wherein each grip contact is active generating, on actuation, an upward grip force on the tote with the grip contact seated against the interior bottom surface of a gripped tote.

7. The automatic product tote destacker tool of claim 4, wherein the tote grip is configured so that the upwards force grips the corresponding tote to the tote pick head so as to effect the tote pick, lifting the corresponding tote free from the stack, with at least one of the multiple grip contacts of the tote pick head inoperative.

8. The automatic product tote destacker tool of claim 1, wherein the tote grip is a vacuum grip generated by a venturi providing a metered suction so as to grip the corresponding tote.

9. The automatic product tote destacker tool of claim 1, wherein the pick head array has at least one distance sensor arranged to determine a bottom of the corresponding tote in the stack.

10. The automatic product tote destacker tool of claim 1, wherein the pick head array has at least one distance sensor arranged so as to determine one or more of sides, edges, and opening of the corresponding tote in the stack.

11. The automatic product tote destacker tool of claim 10, wherein each tote pick head, of the pick head array, has a corresponding one of the at least one distance sensor disposed so that the position of the pick head array is determined relative to a group of the stacks, wherein each tote pick head respectively accesses a different stack, substantially simultaneously, so that the pick head array access the group of stacks, and each different tote pick head enters, captures and tote picks the tote corresponding to the tote pick head substantially simultaneously with each other of the different tote pick heads of the pick head array tote picking totes from the respective stacks of the group.

12. An automatic product tote destacker tool comprising:
a frame with a coupling configured so as to mate the automatic product tote destacker tool to a robot end so that the automatic product tote destacker tool provides the robot with an end effector; and
a pick head array of tote pick heads movably connected to and dependent from the frame, the pick head array being configured to simultaneously hold a tote array to the robot, with a different respective tote, of the tote array, being held by a corresponding tote pick head different from each other tote pick head holding each other different respective tote of the tote array, wherein each tote pick head has a tote grip that engages the tote corresponding to the tote pick head;
each tote pick head being movably coupled to the frame so that the tote pick head moves, as a unit, relative to the robot compliant with a level of the corresponding tote;
wherein the tote pick head is metered so that each separate tote pick head respectively effecting a tote pick from stacked totes separately grips but the corresponding tote from the respective tote pick head for each tote pick effected substantially simultaneously by the pick head array and substantially simultaneously destacking stacks of totes with the automatic product tote destacker tool.

13. The automatic product tote destacker tool of claim 12, further comprising a drive section dependent from the frame and operably coupled to each tote pick head so actuate the tote pick head in at least one direction relative to the robot.

14. The automatic product tote destacker tool of claim 12, wherein, the tote pick head is metered so that, for each tote pick from a stack of totes, the tote pick head automatically and repeatedly picks but the corresponding tote from the stack, substantially throughout each destacking pick by the automatic product tote destacker tool destacking the stack of totes from uppermost to bottom most totes of the stack.

15. The automatic product tote destacker tool of claim 12, wherein the pick head meter configuration effects automatic tote decoupling from the tote grip of the tote pick head upon the tote pick head initiating a tote pick of more than one tote, from the stack of totes, so that each tote pick head that effects the tote pick grips but the corresponding tote destacking the stack.

16. The automatic product tote destacker tool of claim 12, wherein the tote grip is an active grip disposed to capture and grip the corresponding tote to the tote pick head, and the active grip is metered so that the tote and grip decouple upon the tote pick head initiating a tote pick of more than one tote.

17. The automatic product tote destacker tool of claim 12, wherein the tote grip is distributed so that for each tote pick head, the tote grip forms multiple grip contacts configured for engagement with the corresponding tote gripped by the tote pick head.

18. The automatic product tote destacker tool of claim 17, wherein each grip contact of the tote grip is resiliently compliant and disposed to seat on an interior bottom surface of the tote, wherein the tote pick head accesses the tote through an opening of the tote.

19. The automatic product tote destacker tool of claim 18, wherein each grip contact is active generating, on actuation, an upward grip force on the tote with the grip contact seated against the interior bottom surface of a gripped tote.

20. The automatic product tote destacker tool of claim 17, wherein the tote grip is configured so that the upwards force grips the corresponding tote to the tote pick head so as to effect the tote pick, lifting the corresponding tote free from the stack, with at least one of the multiple grip contacts of the tote pick head inoperative.

21. A method of destacking totes with an automatic product tote destacker tool, the method comprising:
providing a frame of the automatic product tote destacker tool, the frame having a coupling configured for mating the automatic product tote destacker tool to a robot end so that the automatic product tote destacker tool provides the robot with an end effector;
providing a pick head array of tote pick heads movably connected to and dependent from the frame, the pick head array being configured for simultaneously holding a tote array to the robot, with a different respective tote, of the tote array, being held by a corresponding tote pick head different from each other tote pick head holding each other different respective tote of the tote array, wherein each tote pick head has a tote grip engaging the tote corresponding to the tote pick head; and
providing a drive section connected to the frame and operably coupled to each tote pick head for moving the tote pick head as a unit, relative to the frame, in compliance with a level of the corresponding tote;
automatically and repeatedly picking totes from a stack of totes, wherein the tote pick head is metered so that, for each tote pick from the stack of totes, the tote pick head automatically and repeatedly picks but the corresponding tote from the stack, substantially throughout each destacking pick by the automatic product tote destacker tool destacking the stack of totes from uppermost to bottommost totes of the stack.
